(19) United States
(12) Patent Application Publication
(10) Pub. No.: US 2026/0270872 A1
(43) Pub. Date: Sep. 10, 2026

(54) SIGNALING FRAMEWORK FOR IMPROVED POWER CONFIGURATION OF VARIOUS USE CASES

(71) Applicant: QUALCOMM Incorporated, San Diego, CA (US)

(72) Inventors: Sai Laxman SAMBARAJU, HYDERABAD (IN); Raghuveer Ramakrishna Srinivas TARIMALA, Hyderabad (IN); Siva Krishna MULAKALURI, Hyderabad (IN); Upendra Ram PRATURI, Hyderabad (IN); Prathyusha Devi KOSALA, Hyderabad (IN); Nazmul ISLAM, Littleton, MA (US); Harshal Jayesh SHAH, AHMEDABAD (IN)

(21) Appl. No.: 19/074,183

(22) Filed: Mar. 7, 2025

(51) Int. Cl. H04W 52/02; H04W 76/28

(52) U.S. Cl. CPC H04W 52/0225; H04W 76/28

(57) ABSTRACT

Methods, systems, and devices for wireless communications are described. A user equipment (UE) may receive control signaling indicating one or more parameters including a discontinuous reception cycle on duration, a DRX cycle length, a DRX inactivity timer, a data inactivity timer or any combination thereof. In some cases, the UE may transmit an uplink message indicating a change of at least one of the one or more parameters and perform wireless communications based on the change. Additionally, or alternatively, the UE may receive additional control signaling indicating a set of candidate scheduling patterns, and the UE may perform wireless communications based on a change of at least one of the one or more parameters and based on determining a current scheduling pattern of the set of candidate scheduling patterns.

### FIELD OF TECHNOLOGY

The following relates to wireless communications, including signaling framework for improved power configuration of various use cases.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving control signaling indicating one or more parameters including a time duration of a discontinuous reception (DRX) cycle on duration, a DRX cycle length, a DRX inactivity timer, a data inactivity timer, or any combination thereof, transmitting an uplink message indicating a change of at least one of the one or more parameters, and performing wireless communications based on the change of the at least one of the one or more parameters.

A UE for wireless communications is described. The UE may include one or more memories storing processor executable code, and one or more processors coupled with the one or more memories. The one or more processors may individually or collectively be operable to execute the code to cause the UE to receive control signaling indicating one or more parameters including a time duration of a DRX cycle on duration, a DRX cycle length, a DRX inactivity timer, a data inactivity timer, or any combination thereof, transmit an uplink message indicating a change of at least one of the one or more parameters, and perform wireless communications based on the change of the at least one of the one or more parameters.

In some examples of the method and UE described herein, transmitting the uplink message may include operations, features, means, or instructions for transmitting, prior to expiration of the DRX inactivity timer, an indication to terminate the DRX inactivity timer.

In some examples of the method and UE described herein, transmitting the uplink message may include operations, features, means, or instructions for transmitting, during an on duration of a DRX cycle, a request to pause uplink grants, downlink grants, or both, for a remainder of the on duration.

Some examples of the method and UE described herein may further include operations, features, means, or instructions for receiving downlink signaling including an acknowledgement message corresponding to the uplink message, where performing the wireless communications based on the change of the at least one of the one or more parameters may be in accordance with the acknowledgement message.

In some examples of the method and UE described herein, the downlink signaling includes a downlink control information (DCI) message, a medium access control (MAC) control element (CE), a random access message, or any combination thereof.

Some examples of the method and UE described herein may further include operations, features, means, or instructions for receiving downlink control signaling including an indication of an acknowledgement mode of operation in which the UE may be to monitor for the acknowledgement message prior to performing the wireless communications based on the change of the at least one of the one or more parameters and monitoring for the downlink signaling including the acknowledgement message based on the indication of the acknowledgement mode of operation, where receiving the downlink signaling may be based on the monitoring.

Some examples of the method and UE described herein may further include operations, features, means, or instructions for receiving downlink control signaling including an indication of an unacknowledged mode of operation in which the UE may be to perform wireless communications based on the change of the at least one of the one or more parameters without receiving an acknowledgement message and entering a DRX sleep state based on the indication of the unacknowledged mode of operation.

In some examples of the method and UE described herein, the uplink message includes a MAC-CE, an uplink control information (UCI) message, a random access message, a non-access stratum scheduling request (NAS SR), or any combination thereof.

In some examples of the method and UE described herein, the uplink message includes an indication of a set of candidate values corresponding to the one or more parameters.

Some examples of the method and UE described herein may further include operations, features, means, or instructions for receiving downlink signaling approving or denying each candidate value of the set of candidate values, where the change of the at least one of the one or more parameters may be based on receiving the downlink signaling.

In some examples of the method and UE described herein, the downlink signaling includes a DCI message, a MAC-CE, a random access message, or any combination thereof.

In some examples of the method and UE described herein, transmitting the uplink message may include operations, features, means, or instructions for transmitting, prior to expiration of the data inactivity timer, an indication to terminate the data inactivity timer.

In some examples of the method and UE described herein, the uplink message further includes an indication of a radio resource control (RRC) state and the change of the at least one of the one or more parameters may be based on the indication.

Some examples of the method and UE described herein may further include operations, features, means, or instructions for receiving, responsive to the indication of the RRC state, a RRC release message, where performing the wireless communications may be based on the RRC release message.

In some examples of the method and UE described herein, the uplink message includes a report including an application type, a data rate transfer requirement, a data burst periodicity, an application latency requirement, or any combination thereof and the change of the at least one of the one or more parameters may be based on transmitting the report.

Some examples of the method and UE described herein may further include operations, features, means, or instructions for receiving downlink signaling based on the uplink message including the report, the downlink signaling including an indication of one or more updated parameter values, the one or more updated parameter values including an updated DRX cycle on duration, an updated DRX cycle length, an updated DRX inactivity timer, an updated data inactivity timer, a search space set group (SSSG) switching parameter, a physical downlink control channel (PDCCH) skipping parameter, a bandwidth part (BWP), a quantity of reception layers, a quantity of transmission layers, a quantity of uplink secondary carriers to be activated, a quantity of downlink secondary carriers to be activated, a quantity of active uplink secondary carriers to be deactivated, a quantity of active downlink secondary carriers to be deactivated, or any combination thereof, where the change of the at least one of the one or more parameters may be based on the one or more updated parameter values.

A UE for wireless communications is described. The UE may include one or more memories storing processor executable code, and one or more processors coupled with the one or more memories. The one or more processors may individually or collectively be operable to execute the code to cause the UE to receive first control signaling indicating a set of candidate scheduling patterns, receive second control signaling indicating one or more parameters including a time duration of a DRX cycle on duration, a DRX cycle length, a DRX inactivity timer, a data inactivity timer, or any combination thereof, and perform wireless communications based on a change of at least one of the one or more parameters, and based on determining a current scheduling pattern of the set of candidate scheduling patterns.

In some examples of the UE described herein, the first control signaling includes system information, a RRC signaling message, a MAC-CE, a DCI message, or any combination thereof.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that provides a signaling framework for improved power configuration of various use cases in accordance with one or more aspects of the present disclosure.

FIG. 2 shows an example of a wireless communications system that provides a signaling framework for improved power configuration of various use cases in accordance with one or more aspects of the present disclosure.

FIG. 3 shows an example of a timeline that provides a signaling framework for improved power configuration of various use cases in accordance with one or more aspects of the present disclosure.

FIG. 4 shows an example of a timeline that provides a signaling framework for improved power configuration of various use cases in accordance with one or more aspects of the present disclosure.

FIG. 5 shows an example of a timeline that provides a signaling framework for improved power configuration of various use cases in accordance with one or more aspects of the present disclosure.

FIG. 6 shows an example of a timeline that provides a signaling framework for improved power configuration of various use cases in accordance with one or more aspects of the present disclosure.

FIG. 7 shows an example of a time series alignment that provides a signaling framework for improved power configuration of various use cases in accordance with one or more aspects of the present disclosure.

FIG. 8 shows an example of a flow diagram that provides a signaling framework for improved power configuration of various use cases in accordance with one or more aspects of the present disclosure.

FIG. 9 shows an example of a process flow that provides a signaling framework for improved power configuration of various use cases in accordance with one or more aspects of the present disclosure.

FIG. 10 shows an example of a process flow that provides a signaling framework for improved power configuration of various use cases in accordance with one or more aspects of the present disclosure.

FIG. 11 shows an example of a process flow that provides a signaling framework for improved power configuration of various use cases in accordance with one or more aspects of the present disclosure.

FIGS. 12 and 13 show block diagrams of devices that support signaling framework for improved power configuration of various use cases in accordance with one or more aspects of the present disclosure.

FIG. 14 shows a block diagram of a communications manager that provides a signaling framework for improved power configuration of various use cases in accordance with one or more aspects of the present disclosure.

FIG. 15 shows a diagram of a system including a device that provides a signaling framework for improved power configuration of various use cases in accordance with one or more aspects of the present disclosure.

FIGS. 16 through 18 show flowcharts illustrating methods that support signaling framework for improved power configuration of various use cases in accordance with one or more aspects of the present disclosure.

### DETAILED DESCRIPTION

In some wireless communications systems, a network may configure a user equipment (UE) with one or more connected discontinuous reception (CDRX) parameters (e.g., a CDRX configuration indicating a CDRX on-duration, a CDRX inactivity timer, a CDRX cycle, or any combination thereof), other power saving parameters, such as a data inactivity timer (e.g., to move the UE from a radio resource control (RRC) connected state to an RRC idle or inactive state upon expiration of the timer), or the like. Such configurations may be generic for an Access Point Name (APN) and bearer (e.g., a default or dedicated bearer) quality of service (QoS) requirements. In some cases, the wireless communications system may implement additional techniques for power savings, such as physical downlink control channel (PDCCH) skipping, sparse PDCCH monitoring, search space set group (SSSG) switching, or any combination thereof. However, these configurations and techniques for power savings may be static or semi-static and consequently may fail to adapt to dynamic traffic profiles and different latency requirements associated with different applications (e.g., music streaming, video streaming, social media voice calls).

That is, the wireless communications system may lack a signaling framework between the UE and the network to monitor and change CDRX and idle DRX (IDRX) configurations to improve power consumption (e.g., based on a traffic profile) at the UE after establishment of a Packet Data Network (PDN) or bearer. Accordingly, wireless communications systems implementing static or semi-static DRX configurations may result in unnecessary power expenditures at the UE for some traffic profiles (e.g., bursty traffic, social media voice calls, among other examples). For instance, a UE performing wireless communications according to a CDRX configuration, a data inactivity timer, or both may remain awake (e.g., or in an active or connected mode) during time durations in which no transmissions are scheduled or likely to occur. Remaining active or awake during such time durations may result in increased power expenditures. However, without a mechanism via which to coordinate more efficient CDRX parameters or data inactivity timers, the UE may consume power by remaining awake for a duration when no communications are scheduled until expiration of a generic (e.g., not specific to a traffic profile) CDRX inactivity timer or data inactivity timer.

Accordingly, the techniques described herein may allow a UE to dynamically negotiate with a network to implement a candidate configuration for a CDRX configuration, a data inactivity timer, or both based on a traffic profile. Additionally, or alternatively, the UE may share, with the network, parameters associated with an application (e.g., application type, data transfer requirements, data burst periodicity, application latency requirements) to configure an improved network configuration. In some examples, the UE may perform wireless communications with the network and track one or more parameters associated with a network configuration (e.g., a CDRX configuration, a data inactivity timer), a traffic profile (e.g., traffic pattern, latency requirements, data burst periodicity), or both.

The UE may transmit an uplink message comprising a request to change at least one of the one or more parameters associated with the network configuration based at least in part on the tracking. For example, the network configuration may be a CDRX configuration, and the UE may transmit a request to terminate a CDRX inactivity timer, to pause grants in a connected state, or to change one or more parameters associated with the CDRX configuration to one or more candidate values indicated in the request. In some cases, the network configuration may be an IDRX configuration associated with a data inactivity timer, and the UE may transmit a request to terminate the data inactivity timer or to change a value of the data inactivity timer to a candidate value indicated in the request. Additionally, or alternatively, the UE may transmit an application data requirements (ADR) report to the network indicating one or more parameters associated with the traffic profile, and the network may determine an updated network configuration that improves power saving at the UE and scheduling at the network.

In some examples, the UE may receive a downlink message in response to the uplink message, and the downlink message may indicate one or more parameters associated with an updated network configuration. For example, the downlink message may acknowledge a request to pause grants or terminate a timer, approve a request to change one or more parameters associated with the CDRX configuration or the value of the data inactivity timer, or indicate an updated network configuration for CDRX or IDRX based on the ADR report. Accordingly, the UE may perform wireless communications with the network in accordance with the updated network configuration. Dynamically updating a network configuration based on a traffic profile in accordance with the techniques described herein may improve power savings and performance at the UE and improve scheduling and resource utilization at the network.

Aspects of the disclosure are initially described in the context of wireless communications systems. Aspects of the disclosures are further illustrated by and described with reference to timelines, time series alignments, flow diagrams, and process flows. Aspects of the disclosure are further illustrated by and described with reference to apparatus diagrams, system diagrams, and flowcharts that relate to signaling framework for improved power configuration of various use cases.

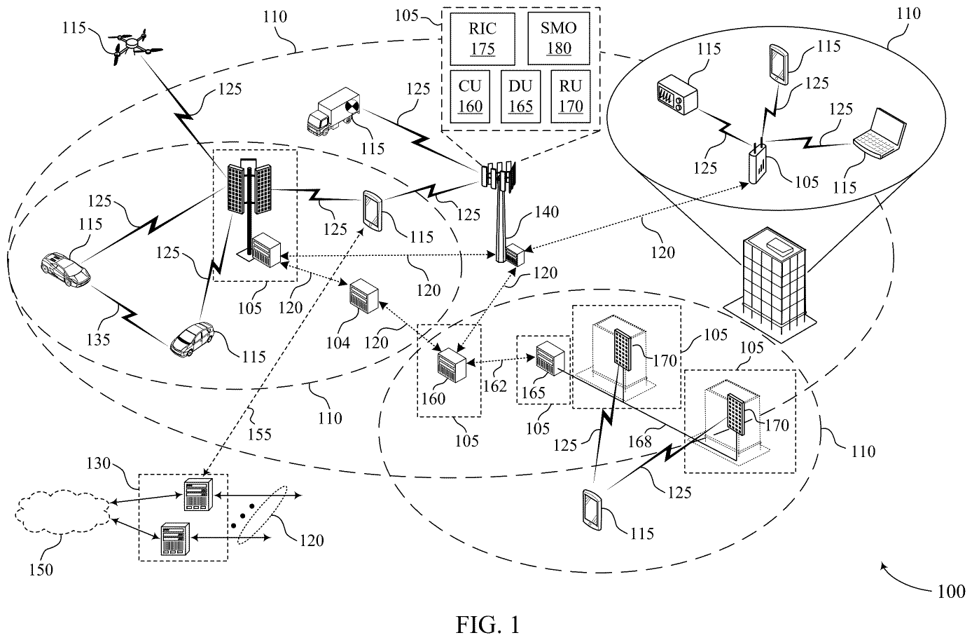

FIG. 1 shows an example of a wireless communications system 100 that provides a signaling framework for improved power configuration of various use cases in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., RRC, service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support signaling framework for improved power configuration of various use cases as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., Nf) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a PDN gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A UE 115 may be configured to for small data transmission (SDT) while operating in an RRC inactive state. The UE 115 may transfer small amounts of data (e.g., 32 bytes to 96 kilobytes) in an RRC inactive state in accordance with a configuration for SDT. The UE 115 may enter the RRC inactive state based on receiving a first RRC release message, which may include a configuration for SDT. In some examples, the UE 115 may transmit a physical random access channel (PRACH) request in accordance with the configuration for SDT, and a network entity 105 may respond with a random access message 2. The UE 115 may transmit, in response to the random access message 2, a random access message 3 including an RRC resume request and uplink data. A timer associated with the configuration for SDT may start when the UE 115 transmits the random access message 3. The network entity 105 may transmit a random access message 4 in response to the random access message 3, and the UE 115 and the network entity 105 may then exchange uplink and downlink data while the timer is running. The network entity 105 may terminate SDT operations by transmitting a second RRC release message to the UE 115, which may include a configuration for SDT (e.g., the same configuration for SDT or a different configuration). Such SDT operations may allow the UE 115 to transfer data in an RRC inactive state without a state transition, which may reduce RRC signaling overhead and allow the UE 115 to quickly move to a low power state after transferring data.

The wireless communications system 100 may provide a signaling framework for dynamically configuring a CDRX configuration, a data inactivity timer, or both based on an application data use case. In some examples of the wireless communications system 100, a UE 115 may track one or more parameters associated with a network configuration, which may include a CDRX cycle on-duration, a CDRX cycle length, a CDRX inactivity timer, a data inactivity timer, or any combination thereof. The UE 115 may, in some implementations, track one or more parameters associated with a use case traffic pattern (e.g., associated with a particular application), which may include an application type used, a data burst periodicity, one or more latency requirements, one or more data transfer requirements, or any combination thereof.

The UE 115 may, based on tracking the one or more parameters associated with the network configuration, the one or more parameters associated with the use case traffic pattern, or both, transmit an uplink message to a network entity 105. In some examples, the uplink message may dynamically trigger termination of a CDRX inactivity timer, explicitly signal to pause grants (e.g., both uplink and downlink grants) while the UE 115 is in an RRC connected state (e.g., for a single CDRX cycle), or request a candidate CDRX configuration (e.g., a candidate CDRX on-duration, a candidate CDRX cycle length, a candidate CDRX inactivity timer, or any combination thereof) in order to improve CDRX sleep residency. In some implementations, the uplink message may dynamically trigger termination of a data inactivity timer or request a candidate data inactivity timer in order to improve residency in an RRC idle or inactive state. Additionally, or alternatively, the UE 115-a may transmit an ADR report including at least a subset of the one or more parameters associated with the use case traffic pattern, and the network entity 105 may dynamically configure a network configuration (e.g., a CDRX configuration, a data inactivity timer) based on the ADR report.

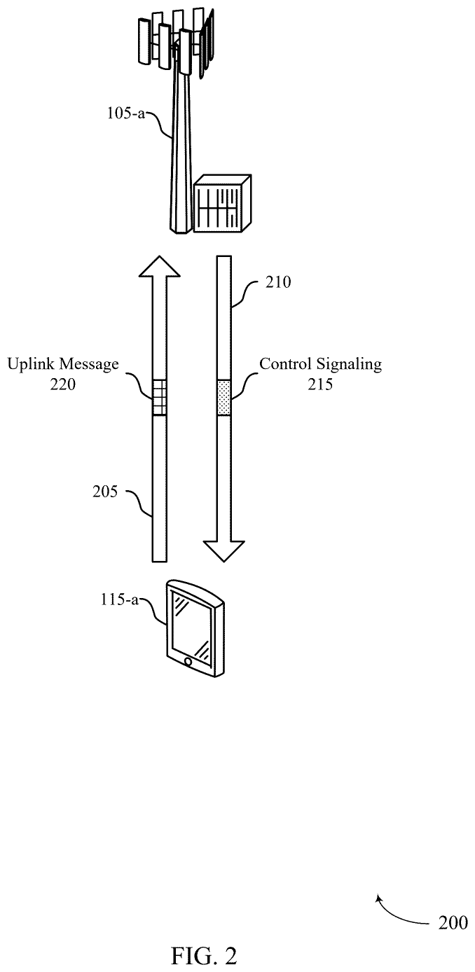

FIG. 2 shows an example of a wireless communications system 200 that provides a signaling framework for improved power configuration of various use cases in accordance with one or more aspects of the present disclosure. In some examples, the wireless communications system 200 may implement, or be implemented by, aspects of wireless communications system 100. For example, the wireless communications system 200 may include a network entity 105-a and a UE 115-a, which may be examples of network entities 105, UEs 115, and other wireless devices as described with reference to FIG. 1.

In some examples of the wireless communications system 200, the network entity 105-a may configure the UE 115-a with one or more CDRX parameters (e.g., a configuration indicating a CDRX on-duration, a CDRX inactivity timer, a CDRX cycle length) and a data inactivity timer (e.g., to move the UE 115-a from an RRC connected state to an RRC idle or inactive state) to save power at the UE 115-a. The configuration for CDRX may allow the UE 115-a to periodically enter a CDRX sleep state (e.g., upon expiration of the CDRX inactivity timer) while the UE 115-a is operating in an RRC connected state. The data inactivity timer may allow the UE 115-a to enter an energy-saving RRC idle or inactive state after a period of inactivity. That is, the data inactivity timer may begin running when the UE 115-a observes a lack of traffic and may continue running until the UE 115-a observes traffic, upon which the data inactivity timer may be reset, or until the data inactivity timer terminates (e.g., reaches an expiry time), at which point the UE 115-a may enter a sleep, idle, or inactive state.

In some cases, the network entity 105-a may configure the UE 115-a with one or more CDRX parameters and a data inactivity timer that are generic for an APN and bearer QoS requirements. That is, the one or more CDRX parameters and the data inactivity timer may be configured based on the APN and the bearer and may remain static or semi-static without considering ongoing dynamic traffic patterns. For example, the network entity 105-a may configure the UE 115-a with a data inactivity timer of 5 seconds to 10 seconds by default. The data inactivity timer may be nonspecific to the UE 115-a and to a data traffic pattern at the UE 115-a.

The network entity 105-a may configure the UE 115-a with one or more other features for improved power savings. The one or more other features may include SSSG switching, PDCCH skipping, spare PDCCH monitoring, or any combination thereof. Additionally, or alternatively, the wireless communications system 200 may implement UE power saving features including wake up signals (WUS), low power WUS, adaptive WUS, or any combination thereof. However, these features for improved power savings may fail to adapt to dynamic traffic profiles and different latency requirements (e.g., associated with different applications or use cases).

In some cases, the UE 115-a may utilize an application (e.g., music streaming, web browsing, video streaming) associated with a data traffic pattern. That is, the UE 115-a may transmit uplink data via an uplink connection 205 and receive downlink data via a downlink connection 210 in accordance with a use case associated with the application. The data traffic pattern and one or more latency requirements may change dynamically based on applications utilized at the UE 115-a. However, the wireless communications system 200 may lack a signaling framework between the UE 115-a and the network (e.g., after establishment of a bearer) to adjust network configurations for power savings. For example, the wireless communications system 200 may lack a framework to dynamically monitor and change the CDRX configuration, the data inactivity timer, or both, based on different data traffic patterns associated with different applications used at the UE 115-a.

Thus, static or semi-static network configurations (e.g., CDRX configurations, data inactivity timers) for power saving may not support power savings at the UE in some use cases (e.g., associated with some applications). For instance, the UE 115-a may support voice calls over social media applications. In such examples, traffic may be transferred every 40 milliseconds, but a typical CDRX configuration for an APN may include a CDRX on-duration of 10 milliseconds and a CDRX inactivity timer of 100 milliseconds. Consequently, the UE 115-a may refrain from entering CDRX sleep because traffic transfers occur more frequently than a duration of the CDRX inactivity timer. In some cases, the UE 115-a may use applications (e.g., music streaming, web browsing, navigation applications) associated with bursty traffic patterns (e.g., traffic occurs in bursts followed by periods of inactivity). In such cases, bursts of traffic may occur more frequently than a duration of a CDRX inactivity timer or a data inactivity timer, causing the UE 115-a to refrain from entering CDRX sleep or IDRX sleep, respectively (e.g., despite the fact that the UE 115-a is often not actually sending or receiving any of the bursty traffic for extended time periods).

The UE 115-a entering CDRX sleep may provide greater power savings than some other features for power savings. Features including WUS, lower power WUS, multiple DRX, PDCCH skipping, spare PDCCH monitoring, and SSSG switching may be static or semi-static (e.g., may not support changing dynamically according to application requirements at the UE 115-a), and accordingly may fail to improve power savings in a use case-specific manner. For example, the UE 115-a may consume about 50 mAB of power to decode PDCCH every slot, but the UE 115-a may reduce power consumption to about 40 mAB by implementing PDCCH skipping (e.g., decoding PDCCH every fourth slot). However, the UE 115-a may reduce power consumption to about 10 mAB by entering CDRX sleep. That is, implementing a CDRX configuration based on an application used at the UE 115-a may offer approximately four to five times greater power savings. Techniques described herein support more dynamic utilization of CDRX configurations to increase such power savings.

Similarly, the UE 115-a entering IDRX sleep may provide greater power savings than other features for power savings. In some cases, the network may configure a data inactivity timer with a default value (e.g., 5 to 10 seconds). The UE 115-a may utilize an application associated with a bursty traffic pattern (e.g., the application has data transfer requirements for a short duration of time followed by a duration of inactivity), and the UE 115-a may go through empty CDRX cycles (e.g., the UE 115-a may have no data transfer requirement during the empty CDRX cycles) for 5 to 10 seconds before expiration of the data inactivity timer. The UE 115-a may consume 10 mAB of power going through these empty CDRX cycles. Some techniques for power savings may improve power consumption of the UE 115-a in an RRC connected state. For example, implementing CDRX with a WUS may reduce power consumption to about 8.5 mAB, and implementing CDRX with adaptive WUS and neighbor cell measurements may reduce power consumption to about 12.8 mAB. However, such power-saving techniques may involve the UE 115-a remaining in the RRC connected state, in which the UE 115-a may consume energy to search and measure neighbor cell events (e.g., intra-frequency neighbors, inter-frequency neighbors, inter-radio access technology neighbors). In contrast, an IDRX configuration allowing the UE 115-a to enter an RRC idle or inactive state (e.g., allowing the UE 115-a to exit the RRC connected state) could further reduce power consumption to about 5 mAB. Techniques described herein support more dynamically or flexibly entering an RRC idle or inactive state (e.g., based on use cases, current traffic, etc.).

Accordingly, techniques described herein may allow the UE 115-a to dynamically enter CDRX sleep, IDRX sleep, or both based on a current traffic profile associated with a particular use case (e.g., based on current traffic patterns, or requirements of an application utilized at the UE 115-a). The network entity 105-a may transmit, via the downlink connection 210, control signaling 215 indicating a time duration of a CDRX on-duration, a CDRX cycle length, a CDRX inactivity timer, a data inactivity timer, or any combination thereof. That is, the control signaling 215 may indicate a configuration for CDRX, IDRX, or both. The UE 115-a may track a network configuration and network conditions (e.g., a CDRX configuration, a data inactivity timer, a signal-to-noise ratio (SNR), a quantity of layers, one or more resource blocks (RBs), a modulation and coding scheme (MCS) allocation, or any combination thereof) based on the control signaling 215. The UE 115-a may also track one or more parameters associated with an application data use case, which may include a traffic pattern, a data burst periodicity, one or more latency requirements, or any combination thereof.

In some examples of the wireless communications system 200, the UE 115-a may transmit an uplink message 220 based on tracking the network configuration, network conditions, the one or more parameters associated with the application data use case, or any combination thereof. In some cases, the uplink message 220 may dynamically trigger termination of the CDRX inactivity timer, explicitly signal to pause grants (e.g., both uplink and downlink grants) while the UE 115-a is in the RRC connected state (e.g., for a single CDRX cycle), or request a candidate (e.g., updated or different) CDRX configuration (e.g., a candidate CDRX on-duration, a candidate CDRX cycle length, a candidate CDRX inactivity timer, or any combination thereof). In such cases, the uplink message 220 may serve to improve CDRX sleep residency (e.g., by allowing the UE 115-a to dynamically enter CDRX sleep) and improve UE power consumption in the RRC connected state for the application data use case. In some examples, the uplink message 220 may dynamically trigger termination of the data inactivity timer or request a candidate (e.g., updated or different) data inactivity timer. In such examples, the uplink message 220 may increase residency in an idle or inactive RRC state, thereby saving power at the UE 115-a. The uplink message 220 may, in some cases, include an ADR report. That is, the UE 115-a may transmit a report including an application type, a data rate transfer requirement, a data burst periodicity, an application latency requirement, or any combination thereof, and the network entity 105-a may dynamically update the network configuration (e.g., a CDRX configuration, an IDRX configuration) to improve the network configuration based on the application data use case.

Additionally, or alternatively, the UE 115-a may implicitly move to a CDRX sleep state based on a network configured scheduling pattern communicated in the control signaling 215. That is, the UE 115-a may determine a current scheduling pattern of the network entity 105-a based on the control signaling 215, and the UE 115-a may dynamically enter CDRX sleep based on the current scheduling pattern. For example, the network entity 105-a may configure the UE 115-a with a default data inactivity timer of 10 milliseconds, and the UE 115-a may determine that the network entity 105-a has recently scheduled the UE 115-a once in every 5 milliseconds for many CDRX on-durations. The UE 115-a may accordingly wait for at least 5 milliseconds of inactivity (e.g., instead of a full 10 milliseconds associated with the data inactivity timer) before entering a CDRX sleep state. In some aspects, the network entity 105-a may configure a scheduling pattern identifier (ID) (e.g., via system information, RRC signaling, a MAC control element (MAC-CE), or a downlink control information (DCI) message) indicating a set of candidate scheduling patterns, and the UE 115-a may determine the current scheduling pattern based on the set of candidate scheduling patterns.

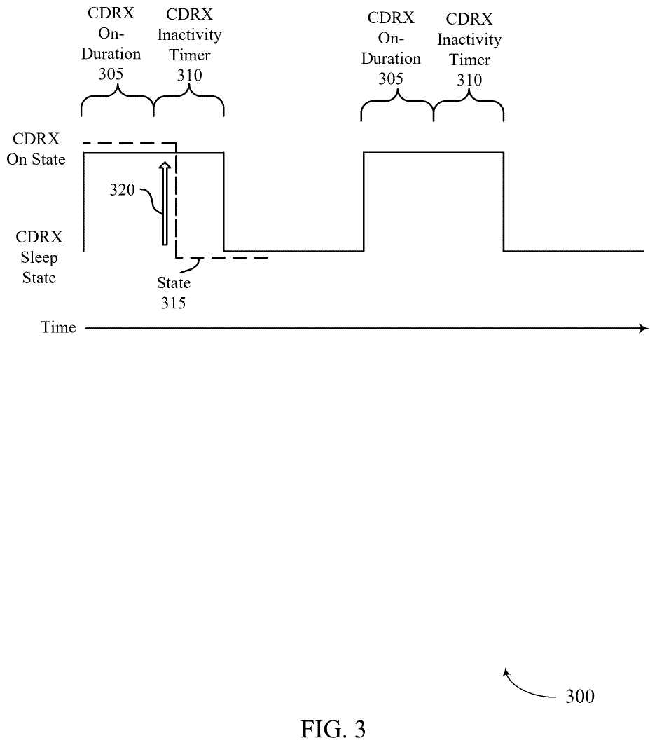

FIG. 3 shows an example of a timeline 300 that provides a signaling framework for improved power configuration of various use cases in accordance with one or more aspects of the present disclosure. In some examples, the timeline 300 may implement, or be implemented by, aspects of wireless communications system 100, or the wireless communications system 200. For example, a UE (e.g., the UE 115-a) and a network entity (e.g., such as the network entity 105-a), which may be examples of corresponding devices described with reference to FIG. 1-2, may communicate with each other in accordance with the timeline 300.

In some examples of the timeline 300, a UE current state 315 at the UE 115-a may alternate between a CDRX on state (e.g., during a CDRX on-duration 305 and the duration of a CDRX inactivity timer 310) and a CDRX sleep state. During the CDRX on-duration 305, the UE may monitor a PDCCH for downlink data. That is, the UE may be in PDCCH decoding mode during the CDRX on-duration 305. The CDRX inactivity timer 310 may begin during or after a CDRX on-duration 305 (e.g., after the UE receives downlink data). The CDRX inactivity timer 310 may run, and the CDRX inactivity timer 310 may run until there is activity at the UE (e.g., downlink data, uplink data) or until termination of the CDRX inactivity timer 310. If the UE receives downlink data or transmits uplink data while the CDRX inactivity timer 310 is running, the CDRX inactivity timer 310 may reset. If the CDRX inactivity timer 310 terminates (e.g., reaches an expiry time), the UE may enter the CDRX sleep state. The UE may refrain from decoding PDCCH while in the CDRX sleep state, thereby saving power at the UE.

In some cases, the UE may transmit an uplink message at 320 to explicitly trigger a termination of the CDRX inactivity timer 310. That is, the UE may transmit, to the network, signaling triggering premature termination (e.g., before the CDRX inactivity timer reaches the expiry time) of the CDRX inactivity timer 310 so that the UE may quickly enter the CDRX sleep state. For example, the UE may dynamically trigger the termination of the CDRX inactivity timer 310 via a MAC-CE (e.g., a logical channel identifier (LCID) included in the MAC-CE), via an uplink control information (UCI) message (e.g., carried by physical uplink control channel (PUCCH) or physical uplink shared channel (PUSCH)), or via a dedicated PRACH resource.

In some examples, a network may operate in either an acknowledged mode or an unacknowledged mode. The network may communicate the mode to the UE in UE-specific (e.g., downlink) signaling (e.g., during call setup). The UE may determine whether to monitor for an acknowledgement message based on an acknowledgement mode of operation (e.g., acknowledged mode or unacknowledged mode). In the unacknowledged mode, the UE may autonomously enter the CDRX sleep state based on transmitting the uplink message at 320. In the acknowledged mode, the network may transmit, and the UE may receive, an acknowledgement of the uplink message. The acknowledgement message may be included in a DCI message (e.g., an ACK message if the UE transmits the uplink message via a MAC-CE or a UCI message), or the acknowledgement message may be or may be included in a random access channel (RACH) message 2 (e.g., if the UE transmit the uplink message via a dedicated PRACH resource). In some cases, the UE may enter the CDRX sleep state based on receiving the acknowledgement message.

Transmission of the uplink message at 320 to explicitly terminate a CDRX inactivity timer 310, as described herein, may improve CDRX sleep residency at the UE, thereby saving power at the UE. That is, the UE may transmit the uplink message to terminate the CDRX inactivity timer 310 based on an application data pattern at the UE and a network scheduling pattern, thereby allowing the UE to dynamically enter the CDRX sleep state to increase power savings. For example, the UE may utilize an application associated with a low data requirement and a bursty traffic pattern (e.g., music streaming, web browsing). The UE may observe traffic (e.g., a burst of traffic) at the beginning of a CDRX on-duration 305, and the UE may expect an absence of traffic for a remainder of the CDRX on-duration 305. Accordingly, the UE may trigger termination of the CDRX inactivity timer 310 via the uplink message at 320 in order to quickly enter CDRX sleep when the UE lacks data to transfer.

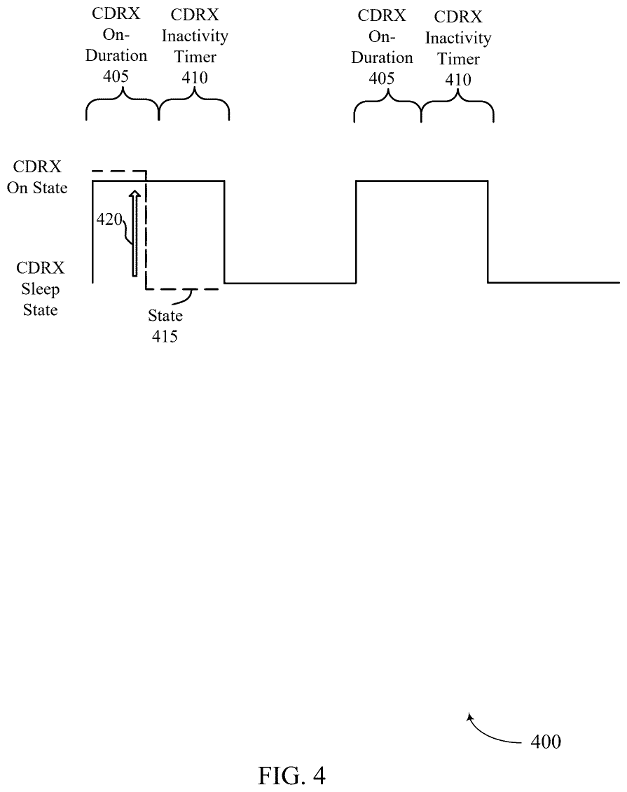

FIG. 4 shows an example of a timeline 400 that provides a signaling framework for improved power configuration of various use cases in accordance with one or more aspects of the present disclosure. In some examples, the timeline 400 may implement, or be implemented by, aspects of wireless communications system 100, the wireless communications system 200, and the timeline 300. For example, a UE (e.g., the UE 115-a) and a network entity (e.g., such as the network entity 105-a), which may be examples of corresponding devices described with reference to FIG. 1-3, may communicate with each other in accordance with the timeline 400.

In some examples of the timeline 400, a UE may alternate between a CDRX on state (e.g., a CDRX on-duration 405 and a CDRX inactivity timer 410) and a CDRX sleep state. During the CDRX on-duration 405, the UE may monitor a PDCCH for downlink data. That is, the UE may be in PDCCH decoding mode during the CDRX on-duration 405. The CDRX inactivity timer 410 may begin after or during the CDRX on-duration 405 (e.g., after the UE receives downlink data). The CDRX inactivity timer 410 may run until there is activity at the UE (e.g., downlink data, uplink data) or until termination of the CDRX inactivity timer 410. If the UE receives downlink data or transmits uplink data while the CDRX inactivity timer 410 is running, the CDRX inactivity timer 410 may reset. If the CDRX inactivity timer 410 terminates (e.g., reaches an expiry time), the UE may change a current state 415 from the CDRX on state to the CDRX sleep state. The UE may refrain from decoding PDCCH while in the CDRX sleep state, thereby saving power at the UE.

In some cases, the UE may transmit an uplink message at 420 to pause grant negotiation (e.g., both uplink and downlink grants) while the UE is in an RRC connected state (e.g., during the CDRX on-duration 405). That is, the UE may transmit, to a network entity, a request that the network refrain from transmitting grants (e.g., uplink or downlink grants) to the UE for a remainder of the CDRX on-duration 405 for a current CDRX cycle. For example, the UE may transmit the uplink message to pause grants via a MAC-CE (e.g., a LCID in the MAC-CE), via a UCI message (e.g., carried by PUCCH or PUSCH), or via a dedicated PRACH resource. In some aspects, the UE may refrain from monitoring for semi-persistent grants, pre-configured grants, or both for a remainder of the current CDRX cycle (e.g., until a subsequent CDRX on-duration 405) based on transmitting the uplink reference signal. In some examples, the UE may trigger transmission of the uplink message at 420 prior to expiration of the CDRX on-duration 405 (e.g., or prior to expiration of the CDRX inactivity timer 410).

In some examples, a network may operate in either an acknowledged mode or an unacknowledged mode. The network may communicate the mode to the UE in UE-specific (e.g., downlink) signaling (e.g., during call setup). The UE may determine whether to monitor for an acknowledgement message based on an acknowledgement mode of operation (e.g., acknowledged mode or unacknowledged mode). In the unacknowledged mode, the UE may autonomously enter the CDRX sleep state based on transmitting the uplink message at 420. For example, the pause in grant negotiation may allow the CDRX inactivity timer 410 to terminate (e.g., reach an expiry time), and the UE may enter the CDRX sleep state based on termination of the CDRX inactivity timer 410. In the acknowledged mode, the network may transmit, and the UE may receive, an acknowledgement of the uplink message. The acknowledgement message may be included in a DCI message (e.g., if the UE transmits the uplink message via a MAC-CE or a UCI message), or the acknowledgement message may be a RACH message 2 (e.g., if the UE transmit the uplink message via a dedicated PRACH resource). In some cases, the UE may enter the CDRX sleep state based on receiving the acknowledgement message.

Transmission of the uplink message at 420 to pause grants in accordance with the techniques described herein may improve CDRX sleep residency at the UE, thereby saving power at the UE. That is, the UE may request a pause in grant negotiation at 420 based on a data pattern at the UE and a network scheduling pattern, thereby allowing the UE to dynamically adjust the timeline 400 to increase power savings. For example, the UE may expect an absence of a data transfer requirement within a CDRX on-duration 405, and the CDRX on-duration 405 may be associated with a high value (e.g., long CDRX on-duration, which may be extended further by the CDRX inactivity timer 410). The transmission of the uplink message at 420 may accordingly allow the UE to enter CDRX sleep quickly when the UE lacks data to transfer.

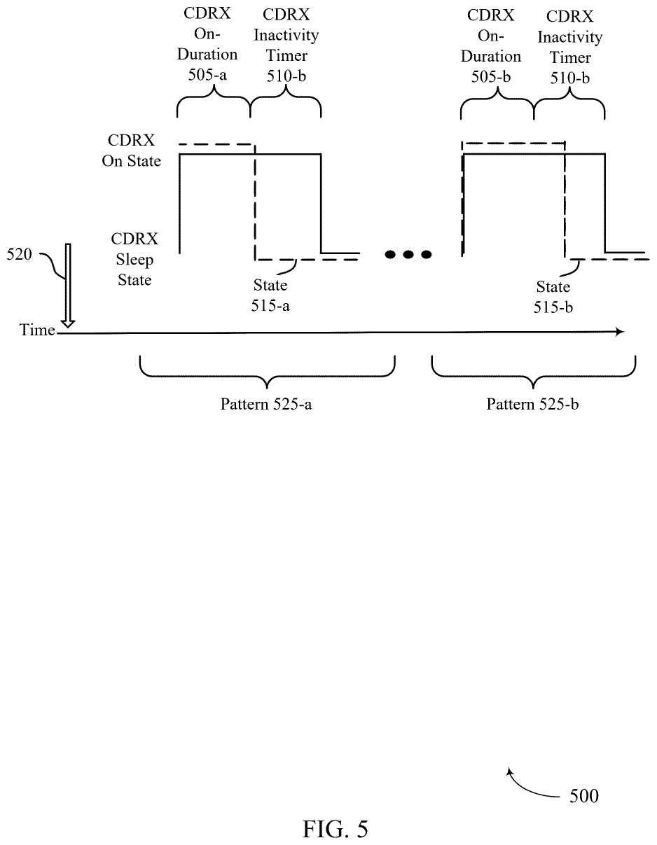

FIG. 5 shows an example of a timeline 500 that provides a signaling framework for improved power configuration of various use cases in accordance with one or more aspects of the present disclosure. In some examples, the timeline 500 may implement, or be implemented by, aspects of wireless communications system 100, the wireless communications system 200, the timeline 300, and the timeline 400. For example, a UE (e.g., the UE 115-a) and a network entity (e.g., such as the network entity 105-a), which may be examples of corresponding devices described with reference to FIG. 1-4, may communicate with each other in accordance with the timeline 500.

At 520, a UE may receive an indication of a scheduling pattern ID. The scheduling pattern ID may indicate a set of candidate scheduling patterns for implementation by the network. A single scheduling pattern ID may contain multiple candidate scheduling patterns 525 (e.g., the network configuring the UE once in every 5 millisecond, 10 millisecond, CDRX cycle, multiple CDRX cycle). In some cases, the network may pre-configure the UE with a set of candidate scheduling patterns during RRC connection setup, or the network may configure the scheduling pattern ID via system information, RRC signaling, a MAC-CE, a DCI message, or any combination thereof. Additionally, or alternatively, the network may configure a wide range of scheduling pattern IDs via RRC signaling, and the network may then activate a subset of the configured scheduling pattern IDs via a MAC-CE.

The UE may determine a current scheduling pattern 525 of the network during wireless communications with the network based on the scheduling pattern ID (e.g., or the activated subset of the configured scheduling pattern IDs). That is, the UE may observe a current scheduling pattern 525 and identify the current scheduling pattern from among the set of candidate scheduling patterns indicated by the scheduling pattern ID. The UE may accordingly move (e.g., implicitly) to a CDRX sleep state based on the identified current scheduling pattern, allowing the UE to improve CDRX sleep residency and save power.

For example, the network may indicate the scheduling pattern ID at 520 (e.g., which may indicate at least a scheduling pattern 525-a and a scheduling pattern 525-b). The UE may observe that the network schedules once in every CDRX cycle (e.g., in accordance with the scheduling pattern 525-a). The UE may accordingly maintain the CDRX on (e.g., awake) state during the CDRX on-duration 505-a, but may enter CDRX sleep after initiation of the CDRX inactivity timer 510-b (e.g., before expiry of the CDRX inactivity timer 510-b) based on determining the scheduling pattern 525-a (e.g., scheduling once in every CDRX cycle). That is, the UE may determine that the network will refrain from configuring the UE again for a remainder of a current CDRX cycle in accordance with the scheduling pattern 525-a, and the UE may accordingly switch its current state 515-a from the CDRX on (e.g., awake) state to a CDRX sleep state to conserve power.

In another example, the network may indicate the scheduling pattern ID at 520 (e.g., including at least the scheduling pattern 525-b). For example, the network may switch from the scheduling pattern 525-a to the scheduling pattern 525-b after a period of time. The UE may observe that the network has scheduled the UE once in every 5 milliseconds for many CDRX on-durations (e.g., including the CDRX on-duration 505-b). That is, the UE may determine that the scheduling pattern 525-b is associated with a scheduling once in every 5 milliseconds. The UE may, in this example, implement a CDRX inactivity timer 510-b (e.g., after the CDRX on-duration 505-b) associated with an expiry time of 10 milliseconds. The UE may accordingly refrain from entering a CDRX sleep state until the CDRX inactivity timer has reached a time of at least 5 milliseconds (e.g., at which point the UE may switch its current state 515-b from the CDRX on state to the CDRX sleep state prior to the expiration of the CDRX inactivity timer 510-b).

The UE implicitly moving to a CDRX sleep state based on determining a network configured scheduling pattern (e.g., based on a scheduling pattern ID, an observed scheduling pattern, or both), as described herein, may allow the UE to improve CDRX sleep residency and thereby save power. That is, the UE may enter CDRX sleep when the network is unlikely to schedule the UE (e.g., based on the current scheduling pattern), and the UE may accordingly enter CDRX sleep more quickly than if the UE entered CDRX sleep after a CDRX inactivity timer reaches an expiry time.

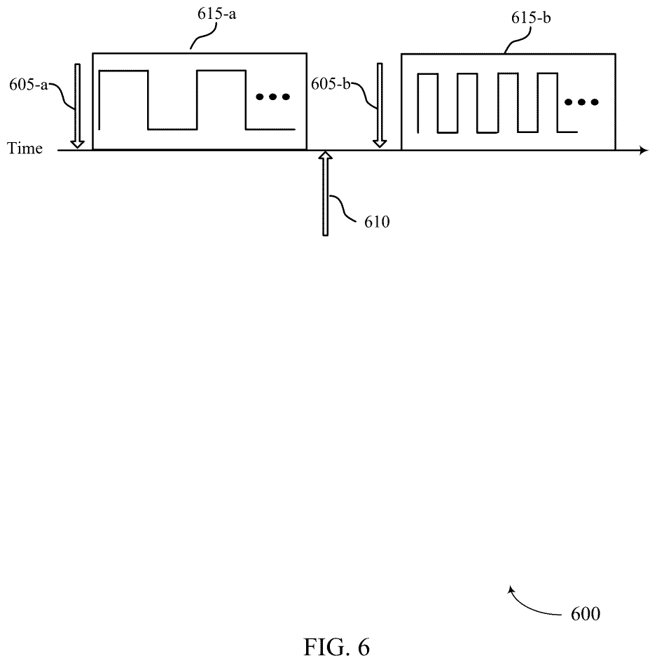

FIG. 6 shows an example of a timeline 600 that provides a signaling framework for improved power configuration of various use cases in accordance with one or more aspects of the present disclosure. In some examples, the timeline 600 may implement, or be implemented by, aspects of wireless communications system 100, the wireless communications system 200, the timeline 300, the timeline 400, and the timeline 500. For example, a UE (e.g., the UE 115-a) and a network entity (e.g., such as the network entity 105-a), which may be examples of corresponding devices described with reference to FIG. 1-5, may communicate with each other in accordance with the timeline 600

In some cases, a UE may operate in accordance with a CDRX configuration 615-a. For example, at 605-a, the network may configure the UE with one or more parameters (e.g., CDRX on durations, CDRX timers, etc.) corresponding to the CDRX configuration 615-a. While operating in accordance with the CDRX configuration 615-a, the UE may track one or more parameters associated with a traffic use case (e.g., the UE may track application requirements). That is, the UE may track a UE data rate, a latency requirement, a data pattern, or the like. The UE may also track network conditions while operating in accordance with the CDRX configuration 615-a. For example, the UE may track a CDRX configuration, a data inactivity timer, an SNR, a quantity of layers, one or more RBs, an MCS allocation, or any combination thereof.

At 610, the UE may transmit a request for a candidate (e.g., updated or different) CDRX configuration based on tracking the one or more parameters and the network conditions. That is, the UE may determine a candidate CDRX configuration based on network conditions and a traffic use case, and the UE may accordingly dynamically negotiate a candidate CDRX configuration with the network. In some examples, the UE may request the candidate CDRX configuration via a MAC-CE (e.g., an LCID), a UCI message (e.g., carried by PUCCH or PUSCH), a dedicated PRACH resource, or any combination thereof. For example, the UE may transmit a MAC-CE or UCI message including an indication of a requested or updated CDRX on duration, CDRX inactivity timer, CDRX cycle length, etc. (e.g., 3 bits indicating a candidate CDRX on-duration, 3 bits indicating a candidate CDRX inactivity timer, and 3 bits indicating a candidate CDRX cycle length).

In one example, the UE may perform a voice call over a social media application. The CDRX configuration 615 may be a generic configuration including a CDRX on-duration of 10 milliseconds, a CDRX cycle length of 160 milliseconds, and a CDRX inactivity timer of 80 milliseconds. A traffic pattern associated with performing the voice call over the social media application may include receiving a grant within at most 32 milliseconds of a previous grant. Accordingly, the UE may fail to enter CDRX sleep when operating in accordance with the CDRX configuration 615. The traffic pattern may also include a relatively low data rate compared to other types of data transmission (e.g., about 64 kilobits per second) and a real-time latency requirement (e.g., about 150 milliseconds). Based on the traffic pattern, the UE may determine the candidate CDRX configuration includes a CDRX on-duration of 10 milliseconds, a CDRX cycle length of 40 to 80 milliseconds, and a CDRX inactivity timer of 10 milliseconds. The candidate CDRX configuration may allow the UE to enter CDRX sleep while performing the voice call over the social media application, and the UE may request the candidate CDRX configuration at 610.

The network may respond (e.g., at 605-b) to the request via a control message, such as a DCI message, a MAC-CE, a RACH message 2 (e.g., if the UE transmitted the request via a dedicated PRACH resource), or a combination thereof. In some cases, the network may approve the candidate CDRX configuration and indicate, to the UE, a change from the CDRX configuration 615-a to the candidate CDRX configuration (e.g., to the CDRX configuration 615-b). Additionally, or alternatively, the network may individually approve or deny each parameter associated with the request. For example, the network may approve the candidate CDRX on-duration and the candidate CDRX inactivity timer, and the network may deny the candidate CDRX cycle length (e.g., the CDRX cycle length may remain unchanged).

The UE may operate in accordance with a CDRX configuration 615-b after negotiating the candidate CDRX configuration with the network. In some examples, the CDRX configuration 615 may be the candidate CDRX configuration. Additionally, or alternatively, the CDRX configuration 615 may be associated with a change in some, but not all, parameters (e.g., a time duration of a CDRX on-duration, a CDRX inactivity timer, a CDRX cycle length, or any combination thereof) relative to the CDRX configuration 615 based on the network response. For example, if the network approves the candidate CDRX on-duration and the candidate CDRX inactivity timer but not the candidate CDRX cycle length, the CDRX configuration 615-b may include the same CDRX cycle length as the CDRX configuration 615-a, the candidate CDRX on-duration, and the candidate CDRX inactivity timer.

Dynamic negotiation of a CDRX configuration based on application requirements at the UE, as described herein, may allow configuration of an improved CDRX configuration for a particular traffic use case, allowing the UE to improve CDRX sleep residency and thereby conserve power. For example, the UE may utilize a music streaming application associated with a bursty traffic pattern (e.g., the UE downloads data at regular intervals followed by periods of inactivity), and the UE may accordingly request a shorter CDRX inactivity timer, a shorter CDRX on-duration, or both, allowing the UE to enter CDRX sleep outside bursts of traffic and consequently improve power savings.

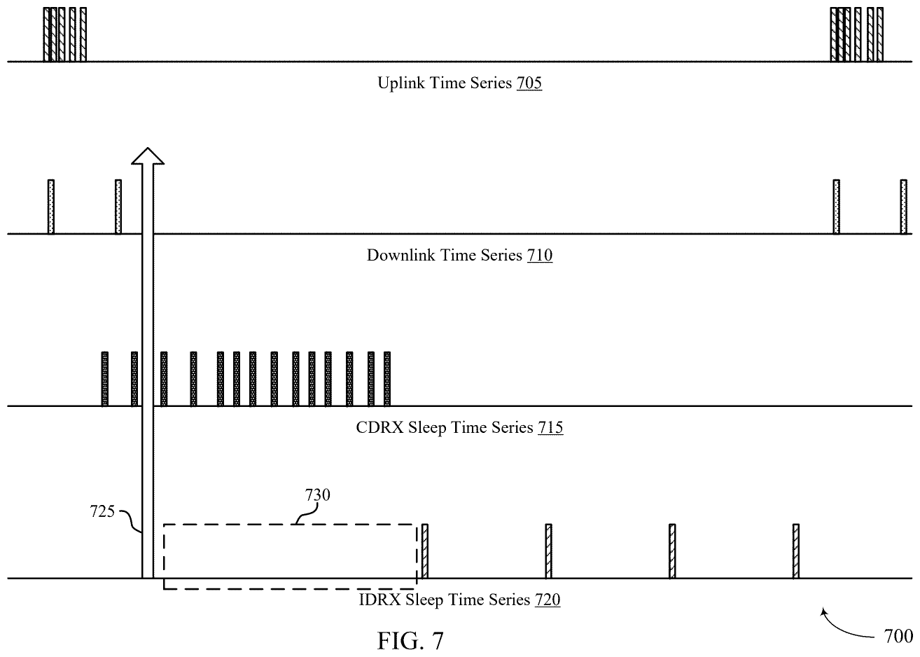

FIG. 7 shows an example of a timeline 700 that provides a signaling framework for improved power configuration of various use cases in accordance with one or more aspects of the present disclosure. In some examples, the timeline 700 may implement, or be implemented by, aspects of wireless communications system 100, the wireless communications system 200, the timeline 300, the timeline 400, the timeline 500, and the timeline 600. For example, the timeline 700 may be implemented by the UE 115-a, the network entity 105-a, or both, as described with reference to FIG. 2.

A UE may operate in accordance with an uplink time series 705 and a downlink time series 710. The uplink time series 705 may indicate a frequency of uplink data transmissions by the UE. For example, the UE may utilize an application associated with a bursty traffic pattern (e.g., music streaming, web browsing, navigation applications), and the uplink time series 705 may include bursts of uplink data (e.g., a series of uplink transmissions within a short time period) followed by periods of inactivity. The downlink time series 710 may indicate a frequency of downlink data transmissions received at the UE. For example, the UE may receive two downlink data transmissions within or close to a time period associated with a burst of uplink data.

In some cases, the UE may operate in accordance with a configuration for CDRX, IDRX, or both. A CDRX configuration may be associated with a CDRX sleep time series 715, which may indicate a frequency of CDRX sleep occasions at the UE. An IDRX configuration may be associated with an IDRX sleep time series 720, which may indicate a frequency of IDRX sleep occasions at the UE. For example, the UE may enter CDRX sleep periodically while operating in an RRC connected state, and the UE may enter IDRX sleep periodically while operating in an idle or an inactive state. In some aspects, the UE may transition from the RRC connected state (e.g., a state of cycling between CDRX sleep and CDRX on-durations) to an idle state or an inactive state based on termination of a data inactivity timer. That is, a UE operating in the RRC connected state may fail to observe traffic for a duration of the data inactivity timer (e.g., until an expiry time) and subsequently enter the idle state or the inactive state.

In some examples, at 725, the UE may transmit an uplink message to trigger the termination of a data inactivity timer based on an application data pattern, a latency requirement, or both. That is, the UE may dynamically trigger premature termination of the data inactivity timer before the data inactivity timer reaches a configured expiry time. The UE may transmit the uplink message to the network via a MAC-CE (e.g., an LCID), a UCI message (e.g., carried by PUCCH or PUSCH), a dedicated PRACH resource, or any combination thereof.

In some aspects, the UE may determine an RRC state for the UE to enter at release and transmit an indication of the RRC state with the uplink message. That is, the UE may determine and indicate to the network a RRC state for the UE to enter upon release from an RRC connected state (e.g., at termination of the data inactivity timer). The UE may determine the RRC state to be an idle state or an inactive state based on requirements of an application used at the UE, an SDT configuration, or both. For example, the UE may utilize an application associated with low data usage, a bursty traffic pattern, or both (e.g., music streaming, navigation applications), and the UE may accordingly determine the RRC state to be the inactive state so that the UE may transfer data in SDT mode (e.g., while operating in the inactive state). In another example, the UE may utilize an application associated with high data usage (e.g., video streaming), and the UE may accordingly determine the RRC state to be the idle state so that the UE may move (e.g., out of the idle state) to an RRC connected state for data transfer.

In such examples, the network may transmit, and the UE may receive, an RRC release message in response to the UE request. The RRC release message may release the UE to the idle state or the inactive state based on the indication. In some cases, the network may transmit the RRC release message with an SDT configuration (e.g., if the indicated RRC state is the inactive state).

Additionally, or alternatively, the UE may transmit an uplink message indicating a candidate data inactivity timer at 725 based on requirements of an application utilized at the UE (e.g., an application data burst periodicity, a latency requirement, or both). That is, the UE may dynamically negotiate a data inactivity timer with the network based on a traffic pattern associated with the application. The UE may transmit the uplink message via a MAC-CE (e.g., an LCID), a UCI message (e.g., carried by PUCCH or PUSCH), or a dedicated PRACH resource. For example, the UE may request the candidate data inactivity timer in a random access message 3, which the UE may transmit during connection establishment as part of a RACH procedure.

In some aspects, the UE may determine an RRC state for the UE to enter at release and indicate the RRC state in the uplink message. That is, the UE may indicate a candidate data inactivity timer and a RRC state to be entered by the UE upon termination of the candidate data inactivity timer. For example, the UE may transmit the uplink message as a MAC-CE including 3 bits indicating a candidate data inactivity timer and 1 bit indicating a RRC state. The RRC state may be an idle state, or the RRC state may be an inactive state in which the UE may operate in SDT mode.

The network may transmit, and the UE may receive, a response to the uplink message requesting the candidate data inactivity timer. That is, the UE may receive signaling either approving or denying the candidate data inactivity timer indicated in the uplink message. The network may transmit the response via a DCI message (e.g., if the uplink message was transmitted via a MAC-CE or a UCI message), or the network may transmit the response via a random access message (e.g., a random access message 2, a random access message 4, or both) if the uplink message was transmitted via a dedicated PRACH resource. In some cases, the network may transmit an indication of a new data inactivity timer, which may be the candidate data inactivity timer.

Transmission of explicit signaling to trigger data inactivity timer termination or to dynamically negotiate a data inactivity timer (e.g., to request a candidate data inactivity timer), as described herein, may allow the UE to operate in the idle state or the inactive state for a time period 730 in which the UE would otherwise remain in an RRC connected state. For example, the uplink time series 705 and the downlink time series 710 may indicate an absence of uplink data transmissions and downlink data transmissions during the time period 730, but the UE may remain in the RRC connected state for multiple empty CDRX cycles, as indicated by the CDRX sleep time series 715, while waiting for the data inactivity timer to reach an expiry time associated with termination, which may be after the time period 730. By transmitting the uplink message at 725, the UE may instead prematurely (e.g., before the expiry time) terminate the data inactivity timer so that the UE may enter the idle state or the inactive state for the time period 730, thereby saving power at the UE.

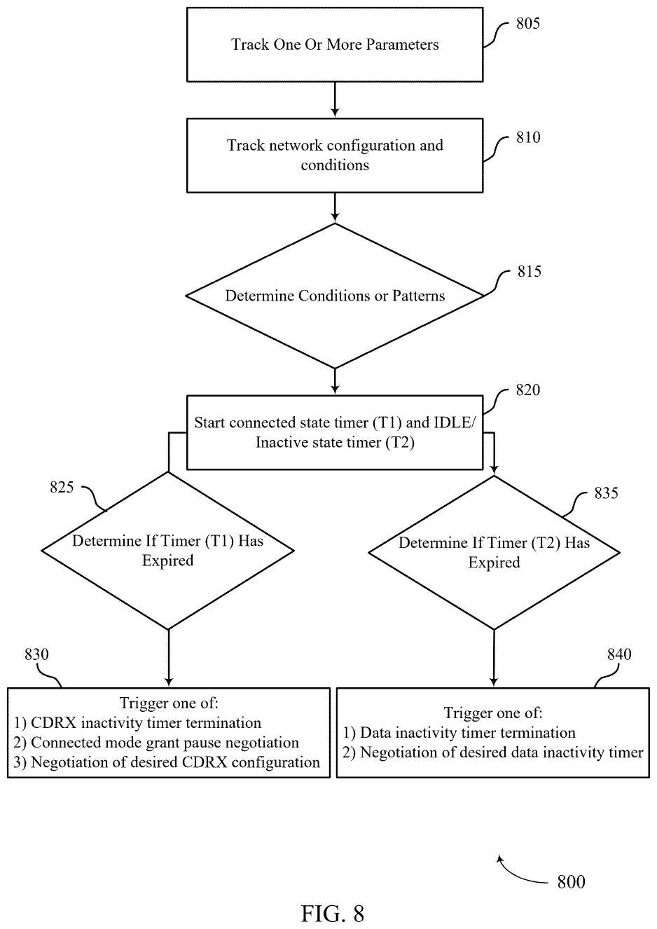

FIG. 8 shows an example of a flow diagram 800 that provides a signaling framework for improved power configuration of various use cases in accordance with one or more aspects of the present disclosure. In some examples, the flow diagram 800 may implement, or be implemented by, aspects of wireless communications system 100, the wireless communications system 200, the timeline 300, the timeline 400, the timeline 500, the timeline 600, and the timeline 700. In some cases, the flow diagram 800 may support transmission of an uplink message to trigger termination of a CDRX inactivity timer, to request a pause in grant negotiation, to request a candidate CDRX configuration, to trigger termination of a data inactivity timer, to request a candidate data inactivity timer, or any combination thereof, as illustrated in FIGS. 2-7 .

At 805, a UE may track one or more parameters (e.g., which may be associated with a use case at the UE). The one or more parameters may include a traffic pattern, a data burst periodicity, one or more latency requirements, or any combination thereof. In some cases, the traffic pattern, the data periodicity, and the one or more latency requirements may vary based on requirements of an application used at the UE (e.g., music streaming, web browsing, social media voice calls). For example, the UE may use a music streaming application associated with a low data requirement and a bursty traffic pattern. The UE may accordingly observe a relaxed latency requirement (e.g., latency may be tolerated) and a data burst periodicity of 10 to 15 seconds (e.g., data is periodically transferred every 10 to 15 seconds).

At 810, the UE may track a network configuration, one or more network conditions, or a combination thereof. The UE may track a CDRX configuration, a data inactivity timer, an SNR, one or more layers, one or more RBs, an MCS allocation, or any combination thereof. For example, the UE may observe that the network has configured a data inactivity timer of 5 to 10 seconds.

At 815, the UE may determine one or more conditions or patterns. The UE may determine the one or more conditions or patterns based on the one or more parameters, the network configuration, the one or more network conditions, or any combination thereof. The one or more conditions or patterns may include the traffic pattern, the data burst periodicity, the one or more latency requirements, the CDRX configuration, other network configurations, the data inactivity timer, the SNR, the one or more layers, the one or more RBs, the MCS allocation, any other conditions or rules, or any combination thereof.

At 820 (e.g., based on the determined conditions or patterns), the UE may start a connected state timer (T1), an idle/inactive state timer (T2) (e.g., associated with either an RRC idle state or an RRC inactive state), or both. For example, the UE may start the connected state timer, the idle/inactive state timer, or both based on determining the one or more conditions or patterns at 815 (e.g., based on the one or more parameters, the network configuration, the one or more network conditions, or any combination thereof). The connected state timer and the idle/inactive state timer may start at corresponding default values and decrease in increments of 1 millisecond until expiry (e.g., the timer reaches a time value of 0) or until the UE receives a grant. If the UE receives a grant while the connected state timer, the idle/inactive state timer, or both are running, the connected state timer, the idle/inactive state timer, or both may reset (e.g., return to the corresponding default values). The corresponding default values of the connected state timer and the idle/inactive state timer may be based on an application traffic profile (e.g., the one or more parameters associated with the use case at the UE). For example, a music streaming application may be associated with a connected state timer default value of 10 milliseconds and an idle/inactive state timer default value of 500 milliseconds.

At 825, the UE may determine if the connected state timer has expired. At 830, the UE may transmit a first uplink message if the UE determines that the connected state timer has expired. In some cases, the first uplink message may trigger termination of a CDRX inactivity timer, as described with reference to FIG. 3. Additionally, or alternatively, the first uplink message may include a request to pause grant negotiation while the UE is in an RRC connected mode (e.g., for a single CDRX cycle), as described with reference to FIG. 4. In some examples, the first uplink message may request a candidate CDRX configuration (e.g., a time duration of a CDRX on-duration, a CDRX inactivity timer, a CDRX cycle length, or any combination thereof), as described with reference to FIG. 6. Transmission of the first uplink message may allow the UE to improve CDRX sleep residency and thereby increase power savings at the UE.

Additionally, or alternatively, at 835, the UE may determine if the idle/inactive state timer has expired. At 840, the UE may transmit a second uplink message if the UE determines that the idle/inactive state timer has expired. In some cases, the second uplink message may trigger termination of a data inactivity timer or request a candidate data inactivity timer, as described with reference to FIG. 7. The UE may enter an idle RRC state or an inactive RRC state based on an RRC state indication transmitted with the second uplink message. The RRC state indication may be based on the use case at the UE (e.g., the application traffic profile). For example, a UE using a music streaming application may indicate the inactive RRC state so that the UE may operate in SDT mode upon release from the RRC connected state. Transmission of the second uplink message and subsequent RRC release may allow the UE to improve residency in the idle RRC state or the inactive RRC state, thereby increasing power savings at the UE.

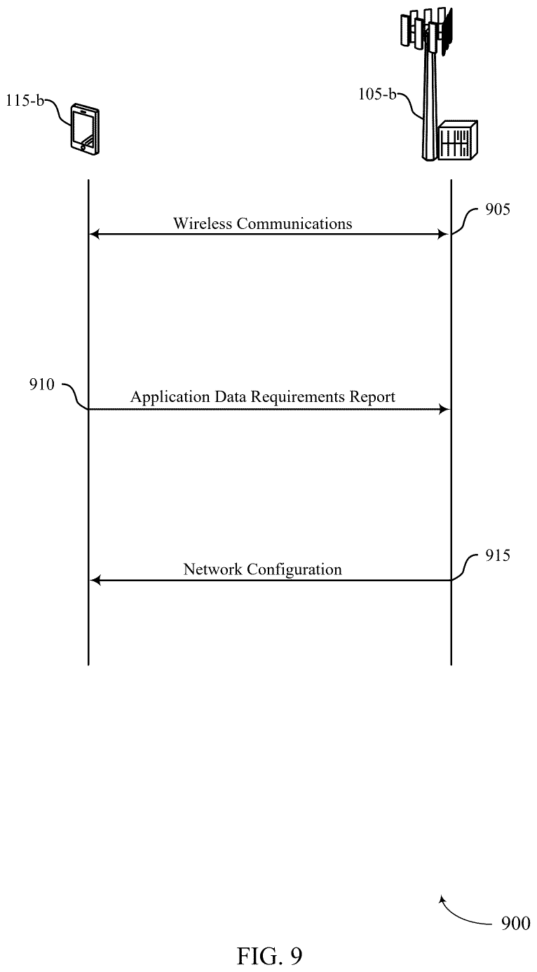

FIG. 9 shows an example of a process flow 900 that provides a signaling framework for improved power configuration of various use cases in accordance with one or more aspects of the present disclosure. In some examples, the process flow 900 may implement or be implemented to realize aspects of the wireless communications system 100 the wireless communications system 200, the timeline 300, the timeline 400, the timeline 500, the timeline 600, the timeline 700, and the flow diagram 800. For example, the process flow 900 may include a UE 115-b and a network entity 105-b, which may be examples of corresponding devices described with reference to FIGS. 1-8 .

In the following description of the process flow 900, the operations between the UE 115-b and the network entity 105-b may occur in a different order than the example order shown and, in some examples, may be performed by one or more different devices other than those shown as examples. Some operations also may be omitted from the process flow 900, and other operations may be added to the process flow 900. Further, although some operations or signaling may be shown to occur at different times for discussion purposes, these operations may actually occur at the same time.

At 905, the UE 115-b may perform wireless communications with the network entity 105-b and track one or more parameters associated with a traffic profile based on performing the wireless communications. That is, the UE 115-b may track one or more parameters associated with data requirements of an application used at the UE 115-b during the wireless communications at 905. For example, the UE 115-b may track a data transfer requirement, a data pattern, a data burst periodicity, a latency requirement, an application type used, or any combination thereof.

At 910, the UE 115-b may transmit an ADR report including the one or more parameters to the network entity 105-b. The UE 115-b may transmit the ADR report via UCI carried by PUCCH or PUSCH as a bitmap, via a MAC-CE (e.g., LCIDs per each combination in a set), via a RACH procedure (e.g., a random access message 5), via a NAS scheduling request (NAS SR), or any combination thereof.

The ADR report may include one or more fields indicating the one or more parameters. For example, the ADR report may include a 3-bit field indicating an application type (e.g., real-time high data, real-time low data, non-real-time high data, non-real-time low data), a 3-bit field indicating a data transfer requirement (e.g., low, medium, high), a 4-bit field indicating a data burst periodicity (e.g., less than 1 second, 5 seconds, 10 seconds, greater than 10 seconds), a 3-bit field indicating a latency requirement (e.g., real-time/latency intolerant, moderate, latency tolerated), or any combination thereof.

At 915, the network entity 105-b may transmit, and the UE 115-b may receive, an updated network configuration based on the ADR report. That is, the network entity 105-b may dynamically update a network configuration based on requirements of an application used at the UE 115-b. The updated network configuration may indicate one or more updated parameter values, including an updated CDRX cycle on-duration, an updated CDRX cycle length, an updated CDRX inactivity timer, an updated data inactivity timer, a SSSG switching parameter, a PDCCH skipping parameter, a BWP, a quantity of reception layers, a quantity of transmission layers, a quantity of uplink secondary carriers to be activated, a quantity of downlink secondary carriers to be activated, a quantity of active uplink secondary carriers to be deactivated, a quantity of active downlink secondary carriers to be deactivated, or any combination thereof. The updated network configuration may improve network scheduling and power savings at the UE 115-b based on the one or more parameters indicated in the ADR report.

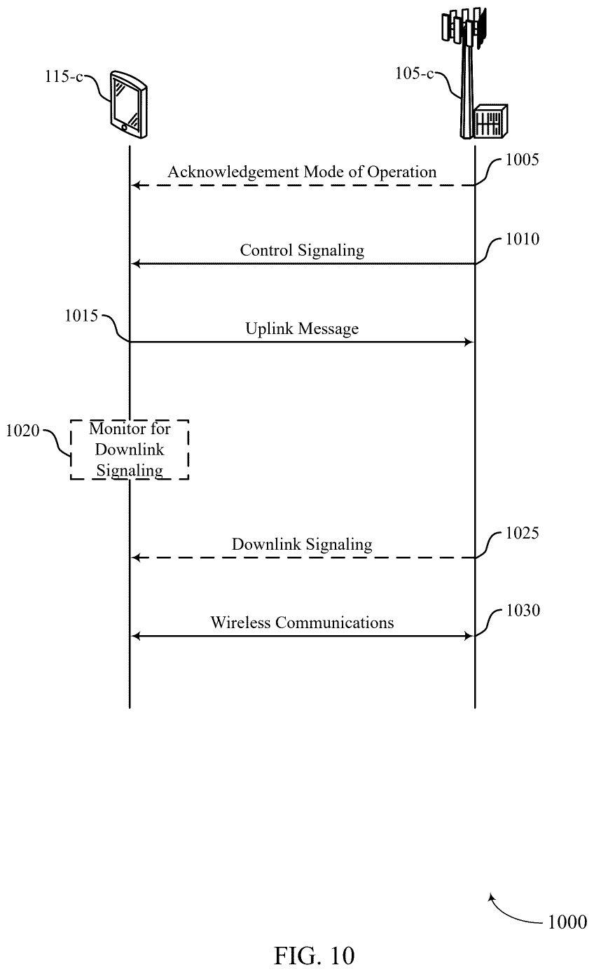

FIG. 10 shows an example of a process flow 1000 that provides a signaling framework for improved power configuration of various use cases in accordance with one or more aspects of the present disclosure. In some examples, the process flow 1000 may implement or be implemented to realize aspects of the wireless communications system 100, the wireless communications system 200, the timeline 300, the timeline 400, the timeline 500, the timeline 600, the timeline 700, the flow diagram 800, and the process flow 900. For example, the process flow 1000 may include a UE 115-c and a network entity 105-c, which may be examples of the UE 115-a and the network entity 105-a, respectively, as illustrated in FIG. 2.

In the following description of the process flow 1000, the operations between the UE 115-c and the network entity 105-c may occur in a different order than the example order shown and, in some examples, may be performed by one or more different devices other than those shown as examples. Some operations also may be omitted from the process flow 1000, and other operations may be added to the process flow 1000. Further, although some operations or signaling may be shown to occur at different times for discussion purposes, these operations may actually occur at the same time.

At 1005, the network entity 105-c may, in some examples, transmit downlink control signaling including an acknowledgement mode of operation to the UE 115-c. That is, the network entity 105-c may indicate to the UE 115-c an acknowledgement mode of operation (e.g., acknowledged mode, unacknowledged mode) during call setup. The acknowledgement mode of operation may determine whether the network entity 105-c is configured to acknowledge an uplink message including an indication to terminate a CDRX inactivity timer, a request to pause grants (e.g., uplink grants, downlink grants, or both) for a remainder of a CDRX on-duration, or both.

At 1010, the network entity 105-c may transmit control signaling indicating one or more parameters to the UE 115-c. The one or more parameters may include a time duration of a CDRX cycle on-duration, a CDRX cycle length, a CDRX inactivity timer, a data inactivity timer, or any combination thereof. In some cases, the UE 115-c may track a network configuration, one or more network conditions, or any combination thereof based on the control signaling. In such cases, the UE 115-c may track a CDRX configuration (e.g., the time duration of the CDRX cycle on-duration, the CDRX cycle length, the CDRX inactivity timer, or any combination thereof), the data inactivity timer, an SNR, a quantity of layers, one or more RBs, an MCS allocation, or any combination thereof.

At 1015, the UE 115-c may transmit, to the network entity 105-c, an uplink message indicating a change of at least one of the one or more parameters. The uplink message may be a MAC-CE, a UCI message, a random access message, a NAS SR, or any combination thereof. In some examples, the uplink message may include an indication to terminate the CDRX inactivity timer (e.g., prior to expiration of the CDRX inactivity timer), as illustrated in FIG. 3, or the uplink message may include an indication to terminate the data inactivity timer (e.g., prior to expiration of the data inactivity timer), as illustrated in FIG. 7. In some cases, the UE 115-c may transmit the uplink message during a CDRX on-duration, and the uplink message may include a request to pause uplink grants, downlink grants, or both for a remainder of the CDRX on-duration, as illustrated in FIG. 4.

Additionally, or alternatively, the uplink message may include an indication of a set of candidate values corresponding to the one or more parameters. For example, the uplink message may indicate a candidate CDRX configuration including a candidate CDRX on-duration, a candidate CDRX cycle length, and a candidate CDRX inactivity timer, as described with reference to FIG. 6. In another example, the uplink message may indicate a candidate data inactivity timer, as described with reference to FIG. 7.

The uplink message may, in some cases, include an ADR report, as described with reference to FIG. 9. The ADR report may indicate one or more parameters including an application type, a data transfer requirement, a data burst periodicity, an application latency requirement, or any combination thereof. The UE 115-c may, in such cases, transmit the ADR report based on tracking a traffic pattern, a data burst periodicity, and one or more latency requirements associated with an application or use case at the UE 115-c.

In some implementations, the uplink message may also include an indication of an RRC state (e.g., an RRC idle state, an RRC inactive state). The indication may indicate a RRC state for an RRC release message, where the UE 115-c enters the RRC state upon receiving the RRC release message. The UE 115-c may determine the RRC state based on requirements of an application used at the UE 115-c. For example, the UE 115-c may utilize a web browsing application and determine the RRC state to be an RRC inactive state so that the UE 115-c may operate in SDT mode upon RRC release.

At 1020, the UE 115-c may, in some cases, monitor for downlink signaling in response to the uplink message. For example, the UE 115-c may monitor for the downlink signaling based on receiving an indication of an acknowledged mode of operation at 1005. The UE 115-c may accordingly monitor for the downlink signaling including an acknowledgement of the uplink message (e.g., transmitted at 1015) based on the indication that the network entity 105-c is configured to operate in the acknowledged mode.

At 1025, the UE 115-c may, in some examples, receive downlink signaling based on transmitting the uplink message at 1015. In some cases, the downlink signaling may include an acknowledgement of the uplink message. For example, the downlink signaling may acknowledge an indication to terminate the CDRX inactivity timer or a request to pause grants (e.g., uplink grants, downlink grants, or both) for a remainder of a CDRX on-duration. In such cases, the downlink signaling may be a DCI message, a MAC-CE, a random access message, or any combination thereof. The UE 115-c may, in some aspects, receive the downlink signaling based on monitoring for the downlink signaling at 1020.

In some examples, the downlink signaling may approve or deny each candidate value of a set of candidate values corresponding to the one or more parameters. For example, the set of candidate values may include a candidate CDRX on-duration, a candidate CDRX cycle length, and a candidate CDRX inactivity timer, and the downlink signaling may approve the candidate CDRX on-duration and the candidate CDRX cycle length but deny the candidate CDRX inactivity timer. Additionally, or alternatively, the UE 115-c may request a candidate data inactivity timer at 1015, and the downlink signaling may approve or deny the candidate data inactivity timer. In such examples, the downlink signaling may be a DCI message, a MAC-CE, a random access message, or any combination thereof.

Additionally, or alternatively, the downlink signaling may include an RRC release message. After receiving the RRC release message, the UE 115-c may enter an RRC state (e.g., an RRC idle or an RRC inactive state) indicated in the uplink message. The RRC release message may, in some implementations, include a configuration for SDT (e.g., if the RRC state is an RRC inactive state).

In cases in which the uplink message includes an ADR report, the downlink signaling may include an indication of one or more updated parameter values. The one or more updated parameters values may include an updated CDRX cycle on-duration, an updated CDRX cycle length, an updated CDRX inactivity timer, an updated data inactivity timer, a SSSG switching parameters, a PDCCH skipping parameter, a BWP, a quantity of reception layers, a quantity of transmission layers, a quantity of uplink secondary carriers to be activated, a quantity of downlink secondary carriers to be activated, a quantity of active uplink secondary carriers to be deactivated, a quantity of active downlink secondary carriers to be deactivated, or any combination thereof. That is, the UE 115-c may receive an updated network configuration based on transmission of the ADR report.

At 1030, the UE 115-c may perform wireless communications with the network entity 105-c based on the change of the at least one of the one or more parameters. In some cases, the UE 115-c may perform the wireless communications in accordance with an acknowledgement (e.g., at 1025) of the uplink message. The change of the at least one of the one or more parameters may, in some aspects, be based on receiving downlink signaling (e.g., at 1025) approving or denying each candidate value of a set of candidate values. For example, the downlink signaling may approve a candidate CDRX inactivity timer, and the UE 115-c may perform wireless communications in accordance with the candidate CDRX inactivity timer. In some implementations, the UE 115-c may receive an indication of an unacknowledged mode of operation at 1005, and the UE 115-c may enter a CDRX sleep state at 1030 based on the indication of the unacknowledged mode of operation (e.g., the UE 115-c may autonomously enter CDRX sleep based on transmitting the uplink message at 1015 without waiting for acknowledgement from the network entity 105-c).

In some implementations, the UE 115-c may receive an RRC release message at 1025, and the UE 115-c may perform wireless communications based on receiving the RRC release message. That is, the UE 115-c may enter, in response to the RRC release message, an RRC idle state or an RRC inactive state and perform wireless communications accordingly. In some aspects, the RRC release message may include a configuration for SDT, and the UE 115-c may enter an RRC inactive state and perform wireless communications in accordance with the configuration for SDT.

In examples in which the uplink message includes an ADR report, the change in the at least one of the one or more parameters may be based on transmission of the ADR report. For example, the network entity 105-c may determine and transmit (e.g., at 1025) an updated network configuration based on one or more parameters (e.g., an application type, a data transfer requirement, a data burst periodicity, an application latency requirement, or any combination thereof) indicated in the ADR report, and the UE 115-c may perform wireless communications with the network entity 105-c based on the updated network configuration.

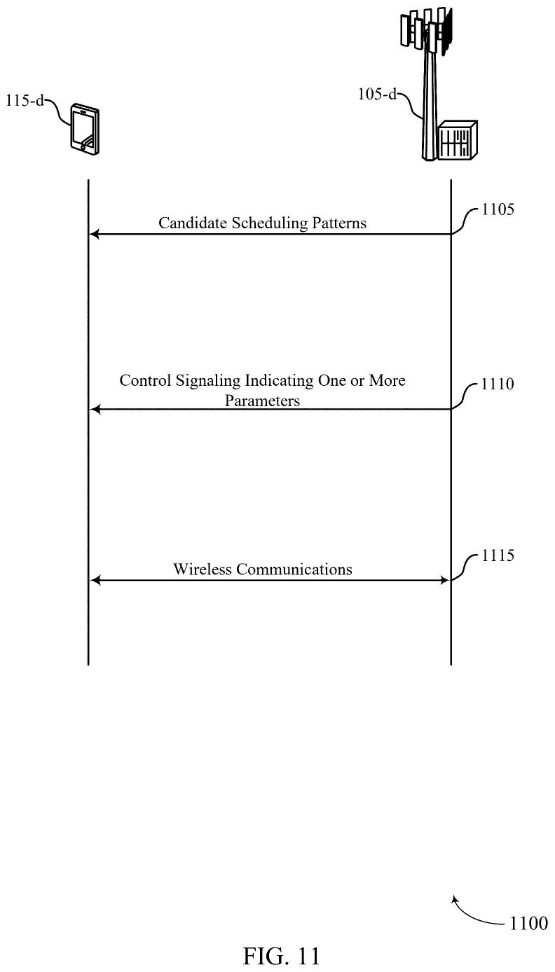

FIG. 11 shows an example of a process flow 1100 that provides a signaling framework for improved power configuration of various use cases in accordance with one or more aspects of the present disclosure. In some examples, the process flow 1100 may implement or be implemented to realize aspects of the wireless communications system 100 or the wireless communications system 200. For example, the process flow 1100 may include a UE 115-d and a network entity 105-d, which may be examples of the UE 115-a and the network entity 105-a, respectively, as illustrated in FIG. 2.

In the following description of the process flow 1100, the operations between the UE 115-d and the network entity 105-d may occur in a different order than the example order shown and, in some examples, may be performed by one or more different devices other than those shown as examples. Some operations also may be omitted from the process flow 1100, and other operations may be added to the process flow 1100. Further, although some operations or signaling may be shown to occur at different times for discussion purposes, these operations may actually occur at the same time.

At 1105, the UE 115-d may receive, from the network entity 105-d, first control signaling indicating a set of candidate scheduling patterns. That is, the UE 115-d may receive an indication of a scheduling pattern ID indicating a set of candidate scheduling patterns for implementation by the network entity 105-d. A single scheduling pattern ID may contain multiple candidate scheduling patterns (e.g., the network configuring the UE 115-d once in every 5 milliseconds, 10 milliseconds, CDRX cycle, multiple CDRX cycle). The network entity 105-d may transmit the set of candidate scheduling patterns via system information, a RRC signaling message, a MAC-CE, a DCI message, or any combination thereof. In some cases, the network entity 105-d may pre-configure the UE 115-d with a set of scheduling patterns during RRC connection setup. Additionally, or alternatively, the network may configure a wide range of scheduling pattern IDs via RRC signaling, and the network may then activate a subset of the configured scheduling pattern IDs via a MAC-CE.

At 1110, the UE 115-d may receive, and the network entity 105-d may transmit, second control signaling indicating one or more parameters. The one or more parameters may include a time duration of a CDRX cycle on-duration, a CDRX cycle length, a CDRX inactivity timer, a data inactivity timer, or any combination thereof.

At 1115, the UE 115-d may perform wireless communications with the network entity 105-d based on a change of at least one of the one or more parameters and determining a current scheduling pattern (e.g., from the set of candidate scheduling patterns) implemented by the network entity 105-d. That is, the UE 115-d may determine the current scheduling pattern of the network from among the set of candidate scheduling patterns, and the UE 115-d may change at least one of the one or more parameters according to which the UE 115-d communicates with the network entity 105-d based on the current scheduling pattern. In some examples, the UE 115-d may implicitly move to a CDRX sleep state based on determining the current scheduling pattern (e.g., the UE 115-d may determine the network entity 105-d is unlikely to schedule the UE 115-d again within a current CDRX on-duration and the UE 115-d may accordingly enter CDRX sleep before expiration of the CDRX inactivity timer).

For example, the UE 115-d may determine that the network entity 105-d schedules the UE 115-d once in every CDRX cycle in accordance with the current scheduling pattern, and the UE 115-d may accordingly enter CDRX sleep after initiation of the CDRX inactivity timer (e.g., before expiry of the CDRX inactivity timer) based on determining the current scheduling pattern (e.g., scheduling once in every CDRX cycle). That is, the UE 115-d may determine that the network entity 105-d will refrain from configuring the UE 115-d again for a remainder of a current CDRX cycle, and the UE 115-d may accordingly switch to a CDRX sleep state to conserve power.

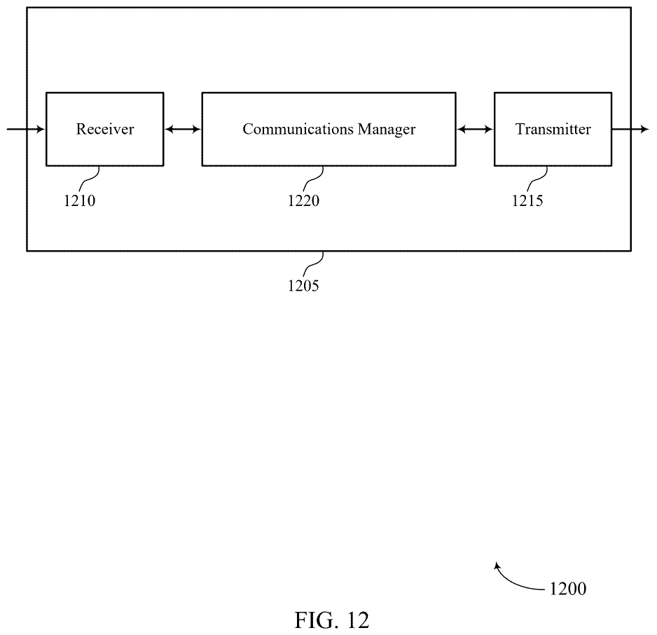

FIG. 12 shows a block diagram 1200 of a device 1205 that provides a signaling framework for improved power configuration of various use cases in accordance with one or more aspects of the present disclosure. The device 1205 may be an example of aspects of a UE 115 as described herein. The device 1205 may include a receiver 1210, a transmitter 1215, and a communications manager 1220. The device 1205, or one or more components of the device 1205 (e.g., the receiver 1210, the transmitter 1215, the communications manager 1220), may include at least one processor, which may be coupled with at least one memory, to, individually or collectively, support or enable the described techniques. Each of these components may be in communication with one another (e.g., via one or more buses).

The receiver 1210 may provide a means for receiving information such as packets, user data, control information, or any combination thereof associated with various information channels (e.g., control channels, data channels, information channels related to signaling framework for improved power configuration of various use cases). Information may be passed on to other components of the device 1205. The receiver 1210 may utilize a single antenna or a set of multiple antennas.

The transmitter 1215 may provide a means for transmitting signals generated by other components of the device 1205. For example, the transmitter 1215 may transmit information such as packets, user data, control information, or any combination thereof associated with various information channels (e.g., control channels, data channels, information channels related to signaling framework for improved power configuration of various use cases). In some examples, the transmitter 1215 may be co-located with a receiver 1210 in a transceiver module. The transmitter 1215 may utilize a single antenna or a set of multiple antennas.

The communications manager 1220, the receiver 1210, the transmitter 1215, or various combinations or components thereof may be examples of means for performing various aspects of signaling framework for improved power configuration of various use cases as described herein. For example, the communications manager 1220, the receiver 1210, the transmitter 1215, or various combinations or components thereof may be capable of performing one or more of the functions described herein.

In some examples, the communications manager 1220, the receiver 1210, the transmitter 1215, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1220, the receiver 1210, the transmitter 1215, or various combinations or components thereof may be implemented in code (e.g., as communications management software or firmware) executed by at least one processor (e.g., referred to as a processor-executable code). If implemented in code executed by at least one processor, the functions of the communications manager 1220, the receiver 1210, the transmitter 1215, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1220 may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communications in accordance with examples as disclosed herein. For example, the communications manager 1220 is capable of, configured to, or operable to support a means for receiving control signaling indicating one or more parameters including a time duration of a DRX cycle on duration, a DRX cycle length, a DRX inactivity timer, a data inactivity timer, or any combination thereof. The communications manager 1220 is capable of, configured to, or operable to support a means for transmitting an uplink message indicating a change of at least one of the one or more parameters. The communications manager 1220 is capable of, configured to, or operable to support a means for performing wireless communications based on the change of the at least one of the one or more parameters.

Additionally, or alternatively, the communications manager 1220 may support wireless communications in accordance with examples as disclosed herein. For example, the communications manager 1220 is capable of, configured to, or operable to support a means for receiving first control signaling indicating a set of candidate scheduling patterns. The communications manager 1220 is capable of, configured to, or operable to support a means for receiving second control signaling indicating one or more parameters including a time duration of a DRX cycle on duration, a DRX cycle length, a DRX inactivity timer, a data inactivity timer, or any combination thereof. The communications manager 1220 is capable of, configured to, or operable to support a means for performing wireless communications based on a change of at least one of the one or more parameters, and based on determining a current scheduling pattern of the set of candidate scheduling patterns.

By including or configuring the communications manager 1220 in accordance with examples as described herein, the device 1205 (e.g., at least one processor controlling or otherwise coupled with the receiver 1210, the transmitter 1215, the communications manager 1220, or a combination thereof) may support techniques for reduced power consumption and more efficient utilization of communication resources.

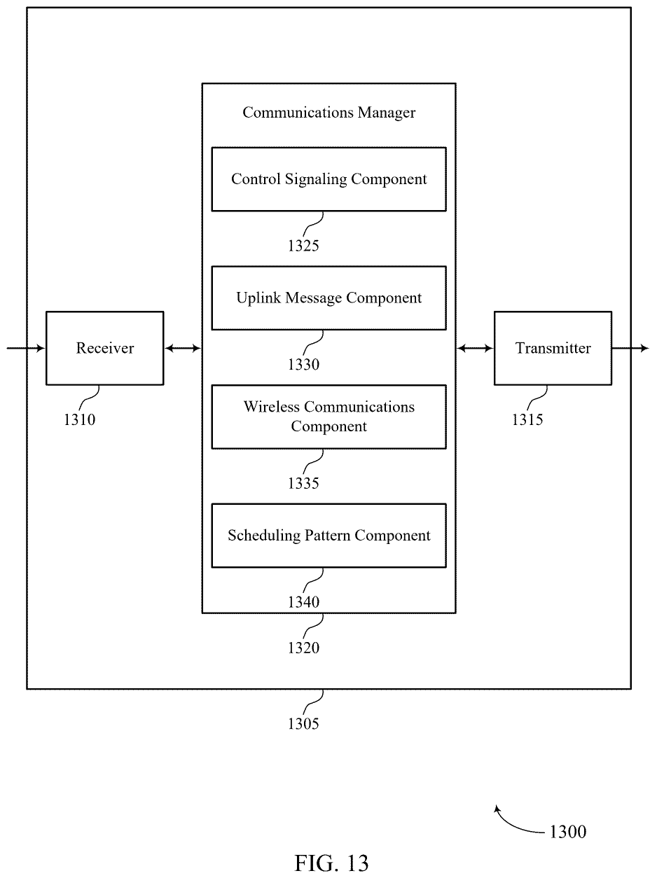

FIG. 13 shows a block diagram 1300 of a device 1305 that provides a signaling framework for improved power configuration of various use cases in accordance with one or more aspects of the present disclosure. The device 1305 may be an example of aspects of a device 1205 or a UE 115 as described herein. The device 1305 may include a receiver 1310, a transmitter 1315, and a communications manager 1320. The device 1305, or one or more components of the device 1305 (e.g., the receiver 1310, the transmitter 1315, the communications manager 1320), may include at least one processor, which may be coupled with at least one memory, to support the described techniques. Each of these components may be in communication with one another (e.g., via one or more buses).

The receiver 1310 may provide a means for receiving information such as packets, user data, control information, or any combination thereof associated with various information channels (e.g., control channels, data channels, information channels related to signaling framework for improved power configuration of various use cases). Information may be passed on to other components of the device 1305. The receiver 1310 may utilize a single antenna or a set of multiple antennas.

The transmitter 1315 may provide a means for transmitting signals generated by other components of the device 1305. For example, the transmitter 1315 may transmit information such as packets, user data, control information, or any combination thereof associated with various information channels (e.g., control channels, data channels, information channels related to signaling framework for improved power configuration of various use cases). In some examples, the transmitter 1315 may be co-located with a receiver 1310 in a transceiver module. The transmitter 1315 may utilize a single antenna or a set of multiple antennas.

The device 1305, or various components thereof, may be an example of means for performing various aspects of signaling framework for improved power configuration of various use cases as described herein. For example, the communications manager 1320 may include a control signaling component 1325, an uplink message component 1330, a wireless communications component 1335, a scheduling pattern component 1340, or any combination thereof. The communications manager 1320 may be an example of aspects of a communications manager 1220 as described herein. In some examples, the communications manager 1320, or various components thereof, may be configured to perform various operations (e.g., receiving, obtaining, monitoring, outputting, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to obtain information, output information, or perform various other operations as described herein.

The communications manager 1320 may support wireless communications in accordance with examples as disclosed herein. The control signaling component 1325 is capable of, configured to, or operable to support a means for receiving control signaling indicating one or more parameters including a time duration of a DRX cycle on duration, a DRX cycle length, a DRX inactivity timer, a data inactivity timer, or any combination thereof. The uplink message component 1330 is capable of, configured to, or operable to support a means for transmitting an uplink message indicating a change of at least one of the one or more parameters. The wireless communications component 1335 is capable of, configured to, or operable to support a means for performing wireless communications based on the change of the at least one of the one or more parameters.

Additionally, or alternatively, the communications manager 1320 may support wireless communications in accordance with examples as disclosed herein. The scheduling pattern component 1340 is capable of, configured to, or operable to support a means for receiving first control signaling indicating a set of candidate scheduling patterns. The control signaling component 1325 is capable of, configured to, or operable to support a means for receiving second control signaling indicating one or more parameters including a time duration of a DRX cycle on duration, a DRX cycle length, a DRX inactivity timer, a data inactivity timer, or any combination thereof. The wireless communications component 1335 is capable of, configured to, or operable to support a means for performing wireless communications based on a change of at least one of the one or more parameters, and based on determining a current scheduling pattern of the set of candidate scheduling patterns.

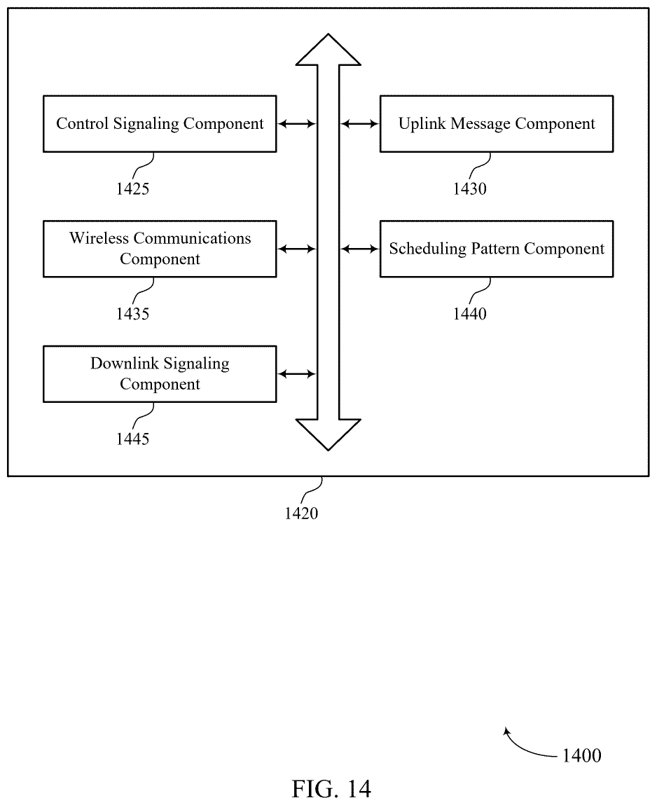

FIG. 14 shows a block diagram 1400 of a communications manager 1420 that provides a signaling framework for improved power configuration of various use cases in accordance with one or more aspects of the present disclosure. The communications manager 1420 may be an example of aspects of a communications manager 1220, a communications manager 1320, or both, as described herein. The communications manager 1420, or various components thereof, may be an example of means for performing various aspects of signaling framework for improved power configuration of various use cases as described herein. For example, the communications manager 1420 may include a control signaling component 1425, an uplink message component 1430, a wireless communications component 1435, a scheduling pattern component 1440, a downlink signaling component 1445, or any combination thereof. Each of these components, or components or subcomponents thereof (e.g., one or more processors, one or more memories), may communicate, directly or indirectly, with one another (e.g., via one or more buses).

The communications manager 1420 may support wireless communications in accordance with examples as disclosed herein. The control signaling component 1425 is capable of, configured to, or operable to support a means for receiving control signaling indicating one or more parameters including a time duration of a DRX cycle on duration, a DRX cycle length, a DRX inactivity timer, a data inactivity timer, or any combination thereof. The uplink message component 1430 is capable of, configured to, or operable to support a means for transmitting an uplink message indicating a change of at least one of the one or more parameters. The wireless communications component 1435 is capable of, configured to, or operable to support a means for performing wireless communications based on the change of the at least one of the one or more parameters.

In some examples, to support transmitting the uplink message, the uplink message component 1430 is capable of, configured to, or operable to support a means for transmitting, prior to expiration of the DRX inactivity timer, an indication to terminate the DRX inactivity timer.

In some examples, to support transmitting the uplink message, the uplink message component 1430 is capable of, configured to, or operable to support a means for transmitting, during an on duration of a DRX cycle, a request to pause uplink grants, downlink grants, or both, for a remainder of the on duration.

In some examples, the downlink signaling component 1445 is capable of, configured to, or operable to support a means for receiving downlink signaling including an acknowledgement message corresponding to the uplink message, where performing the wireless communications based on the change of the at least one of the one or more parameters is in accordance with the acknowledgement message.

In some examples, the downlink signaling includes a DCI message, a MAC-CE, a random access message, or any combination thereof.

In some examples, the control signaling component 1425 is capable of, configured to, or operable to support a means for receiving downlink control signaling including an indication of an acknowledgement mode of operation in which the UE is to monitor for the acknowledgement message prior to performing the wireless communications based on the change of the at least one of the one or more parameters. In some examples, the downlink signaling component 1445 is capable of, configured to, or operable to support a means for monitoring for the downlink signaling including the acknowledgement message based on the indication of the acknowledgement mode of operation, where receiving the downlink signaling is based on the monitoring.

In some examples, the control signaling component 1425 is capable of, configured to, or operable to support a means for receiving downlink control signaling including an indication of an unacknowledged mode of operation in which the UE is to perform wireless communications based on the change of the at least one of the one or more parameters without receiving an acknowledgement message. In some examples, the wireless communications component 1435 is capable of, configured to, or operable to support a means for entering a DRX sleep state based on the indication of the unacknowledged mode of operation.

In some examples, the uplink message includes a MAC-CE, a UCI message, a random access message, a NAS SR, or any combination thereof.

In some examples, the uplink message includes an indication of a set of candidate values corresponding to the one or more parameters.

In some examples, the downlink signaling component 1445 is capable of, configured to, or operable to support a means for receiving downlink signaling approving or denying each candidate value of the set of candidate values, where the change of the at least one of the one or more parameters is based on receiving the downlink signaling.

In some examples, the downlink signaling includes a DCI message, a MAC-CE, a random access message, or any combination thereof.

In some examples, to support transmitting the uplink message, the uplink message component 1430 is capable of, configured to, or operable to support a means for transmitting, prior to expiration of the data inactivity timer, an indication to terminate the data inactivity timer.

In some examples, the uplink message further includes an indication of an RRC state. In some examples, the change of the at least one of the one or more parameters is based on the indication.

In some examples, the downlink signaling component 1445 is capable of, configured to, or operable to support a means for receiving, responsive to the indication of the RRC state, a RRC release message, where performing the wireless communications is based on the RRC release message.

In some examples, the uplink message includes a report including an application type, a data rate transfer requirement, a data burst periodicity, an application latency requirement, or any combination thereof. In some examples, the change of the at least one of the one or more parameters is based on transmitting the report.

In some examples, the downlink signaling component 1445 is capable of, configured to, or operable to support a means for receiving downlink signaling based on the uplink message including the report, the downlink signaling including an indication of one or more updated parameter values, the one or more updated parameter values including an updated DRX cycle on duration, an updated DRX cycle length, an updated DRX inactivity timer, an updated data inactivity timer, an SSSG switching parameter, a PDCCH skipping parameter, a BWP, a quantity of reception layers, a quantity of transmission layers, a quantity of uplink secondary carriers to be activated, a quantity of downlink secondary carriers to be activated, a quantity of active uplink secondary carriers to be deactivated, a quantity of active downlink secondary carriers to be deactivated, or any combination thereof, where the change of the at least one of the one or more parameters is based on the one or more updated parameter values.

Additionally, or alternatively, the communications manager 1420 may support wireless communications in accordance with examples as disclosed herein. The scheduling pattern component 1440 is capable of, configured to, or operable to support a means for receiving first control signaling indicating a set of candidate scheduling patterns. In some examples, the control signaling component 1425 is capable of, configured to, or operable to support a means for receiving second control signaling indicating one or more parameters including a time duration of a DRX cycle on duration, a DRX cycle length, a DRX inactivity timer, a data inactivity timer, or any combination thereof. In some examples, the wireless communications component 1435 is capable of, configured to, or operable to support a means for performing wireless communications based on a change of at least one of the one or more parameters, and based on determining a current scheduling pattern of the set of candidate scheduling patterns.

In some examples, the first control signaling includes system information, a RRC signaling message, a MAC-CE, a DCI message, or any combination thereof.

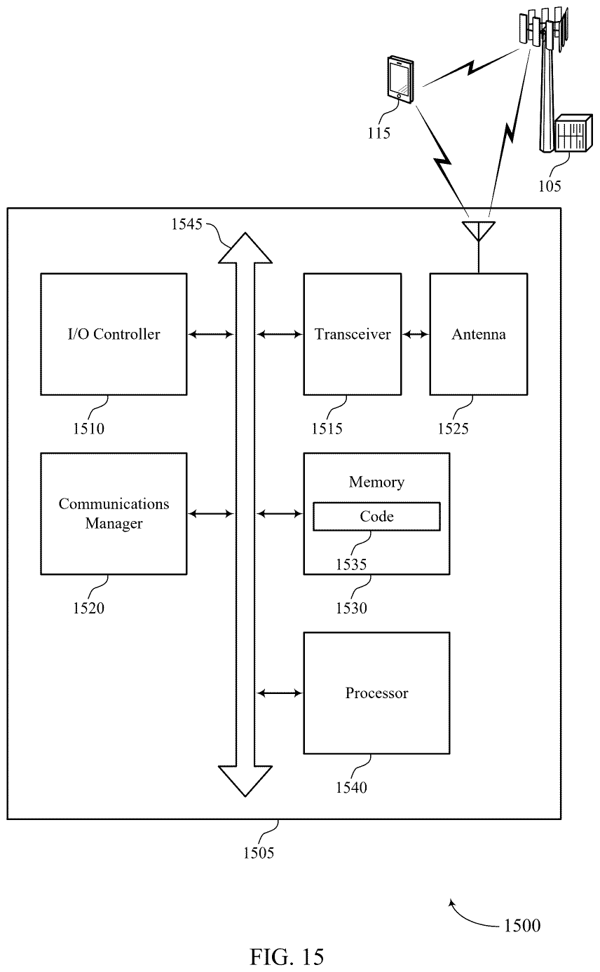

FIG. 15 shows a diagram of a system 1500 including a device 1505 that provides a signaling framework for improved power configuration of various use cases in accordance with one or more aspects of the present disclosure. The device 1505 may be an example of or include components of a device 1205, a device 1305, or a UE 115 as described herein. The device 1505 may communicate (e.g., wirelessly) with one or more other devices (e.g., network entities 105, UEs 115, or a combination thereof). The device 1505 may include components for bi-directional voice and data communications including components for transmitting and receiving communications, such as a communications manager 1520, an input/output (I/O) controller, such as an I/O controller 1510, a transceiver 1515, one or more antennas 1525, at least one memory 1530, code 1535, and at least one processor 1540. These components may be in electronic communication or otherwise coupled (e.g., operatively, communicatively, functionally, electronically, electrically) via one or more buses (e.g., a bus 1545).

The I/O controller 1510 may manage input and output signals for the device 1505. The I/O controller 1510 may also manage peripherals not integrated into the device 1505. In some cases, the I/O controller 1510 may represent a physical connection or port to an external peripheral. In some cases, the I/O controller 1510 may utilize an operating system such as iOS®, ANDROID®, MS-DOS®, MS-WINDOWS®, OS/2®, UNIX®, LINUX®, or another known operating system. Additionally, or alternatively, the I/O controller 1510 may represent or interact with a modem, a keyboard, a mouse, a touchscreen, or a similar device. In some cases, the I/O controller 1510 may be implemented as part of one or more processors, such as the at least one processor 1540. In some cases, a user may interact with the device 1505 via the I/O controller 1510 or via hardware components controlled by the I/O controller 1510.

In some cases, the device 1505 may include a single antenna. However, in some other cases, the device 1505 may have more than one antenna, which may be capable of concurrently transmitting or receiving multiple wireless transmissions. The transceiver 1515 may communicate bi-directionally via the one or more antennas 1525 using wired or wireless links as described herein. For example, the transceiver 1515 may represent a wireless transceiver and may communicate bi-directionally with another wireless transceiver. The transceiver 1515 may also include a modem to modulate the packets, to provide the modulated packets to one or more antennas 1525 for transmission, and to demodulate packets received from the one or more antennas 1525. The transceiver 1515, or the transceiver 1515 and one or more antennas 1525, may be an example of a transmitter 1215, a transmitter 1315, a receiver 1210, a receiver 1310, or any combination thereof or component thereof, as described herein.

The at least one memory 1530 may include random access memory (RAM) and read-only memory (ROM). The at least one memory 1530 may store computer-readable, computer-executable, or processor-executable code, such as the code 1535. The code 1535 may include instructions that, when executed by the at least one processor 1540, cause the device 1505 to perform various functions described herein. The code 1535 may be stored in a non-transitory computer-readable medium such as system memory or another type of memory. In some cases, the code 1535 may not be directly executable by the at least one processor 1540 but may cause a computer (e.g., when compiled and executed) to perform functions described herein. In some cases, the at least one memory 1530 may include, among other things, a basic I/O system (BIOS) which may control basic hardware or software operation such as the interaction with peripheral components or devices.

The at least one processor 1540 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1540 may be configured to operate a memory array using a memory controller. In some other cases, a memory controller may be integrated into the at least one processor 1540. The at least one processor 1540 may be configured to execute computer-readable instructions stored in a memory (e.g., the at least one memory 1530) to cause the device 1505 to perform various functions (e.g., functions or tasks supporting signaling framework for improved power configuration of various use cases). For example, the device 1505 or a component of the device 1505 may include at least one processor 1540 and at least one memory 1530 coupled with or to the at least one processor 1540, the at least one processor 1540 and the at least one memory 1530 configured to perform various functions described herein.

In some examples, the at least one processor 1540 may include multiple processors and the at least one memory 1530 may include multiple memories. One or more of the multiple processors may be coupled with one or more of the multiple memories, which may, individually or collectively, be configured to perform various functions described herein. In some examples, the at least one processor 1540 may be a component of a processing system, which may refer to a system (such as a series) of machines, circuitry (including, for example, one or both of processor circuitry (which may include the at least one processor 1540) and memory circuitry (which may include the at least one memory 1530)), or components, that receives or obtains inputs and processes the inputs to produce, generate, or obtain a set of outputs. The processing system may be configured to perform one or more of the functions described herein. For example, the at least one processor 1540 or a processing system including the at least one processor 1540 may be configured to, configurable to, or operable to cause the device 1505 to perform one or more of the functions described herein. Further, as described herein, being “configured to,” being “configurable to,” and being “operable to” may be used interchangeably and may be associated with a capability, when executing code 1535 (e.g., processor-executable code) stored in the at least one memory 1530 or otherwise, to perform one or more of the functions described herein.

The communications manager 1520 may support wireless communications in accordance with examples as disclosed herein. For example, the communications manager 1520 is capable of, configured to, or operable to support a means for receiving control signaling indicating one or more parameters including a time duration of a DRX cycle on duration, a DRX cycle length, a DRX inactivity timer, a data inactivity timer, or any combination thereof. The communications manager 1520 is capable of, configured to, or operable to support a means for transmitting an uplink message indicating a change of at least one of the one or more parameters. The communications manager 1520 is capable of, configured to, or operable to support a means for performing wireless communications based on the change of the at least one of the one or more parameters.

Additionally, or alternatively, the communications manager 1520 may support wireless communications in accordance with examples as disclosed herein. For example, the communications manager 1520 is capable of, configured to, or operable to support a means for receiving first control signaling indicating a set of candidate scheduling patterns. The communications manager 1520 is capable of, configured to, or operable to support a means for receiving second control signaling indicating one or more parameters including a time duration of a DRX cycle on duration, a DRX cycle length, a DRX inactivity timer, a data inactivity timer, or any combination thereof. The communications manager 1520 is capable of, configured to, or operable to support a means for performing wireless communications based on a change of at least one of the one or more parameters, and based on determining a current scheduling pattern of the set of candidate scheduling patterns.

By including or configuring the communications manager 1520 in accordance with examples as described herein, the device 1505 may support techniques for reduced power consumption, more efficient utilization of communication resources, and longer battery life.

In some examples, the communications manager 1520 may be configured to perform various operations (e.g., receiving, monitoring, transmitting) using or otherwise in cooperation with the transceiver 1515, the one or more antennas 1525, or any combination thereof. Although the communications manager 1520 is illustrated as a separate component, in some examples, one or more functions described with reference to the communications manager 1520 may be supported by or performed by the at least one processor 1540, the at least one memory 1530, the code 1535, or any combination thereof. For example, the code 1535 may include instructions executable by the at least one processor 1540 to cause the device 1505 to perform various aspects of signaling framework for improved power configuration of various use cases as described herein, or the at least one processor 1540 and the at least one memory 1530 may be otherwise configured to, individually or collectively, perform or support such operations.

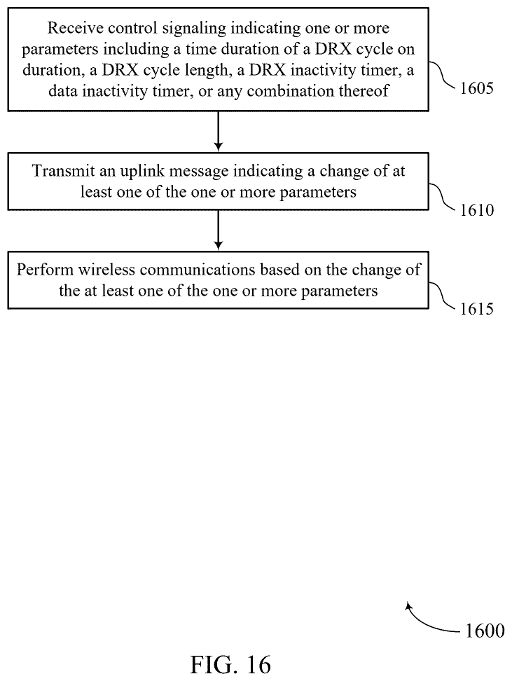

FIG. 16 shows a flowchart illustrating a method 1600 that provides a signaling framework for improved power configuration of various use cases in accordance with one or more aspects of the present disclosure. The operations of the method 1600 may be implemented by a UE or its components as described herein. For example, the operations of the method 1600 may be performed by a UE 115 as described with reference to FIGS. 1 through 15. In some examples, a UE may execute a set of instructions to control the functional elements of the UE to perform the described functions. Additionally, or alternatively, the UE may perform aspects of the described functions using special-purpose hardware.

At 1605, the method may include receiving control signaling indicating one or more parameters including a time duration of a DRX cycle on duration, a DRX cycle length, a DRX inactivity timer, a data inactivity timer, or any combination thereof. The operations of 1605 may be performed in accordance with examples as disclosed herein. In some examples, aspects of the operations of 1605 may be performed by a control signaling component 1425 as described with reference to FIG. 14.

At 1610, the method may include transmitting an uplink message indicating a change of at least one of the one or more parameters. The operations of 1610 may be performed in accordance with examples as disclosed herein. In some examples, aspects of the operations of 1610 may be performed by an uplink message component 1430 as described with reference to FIG. 14.

At 1615, the method may include performing wireless communications based on the change of the at least one of the one or more parameters. The operations of 1615 may be performed in accordance with examples as disclosed herein. In some examples, aspects of the operations of 1615 may be performed by a wireless communications component 1435 as described with reference to FIG. 14.

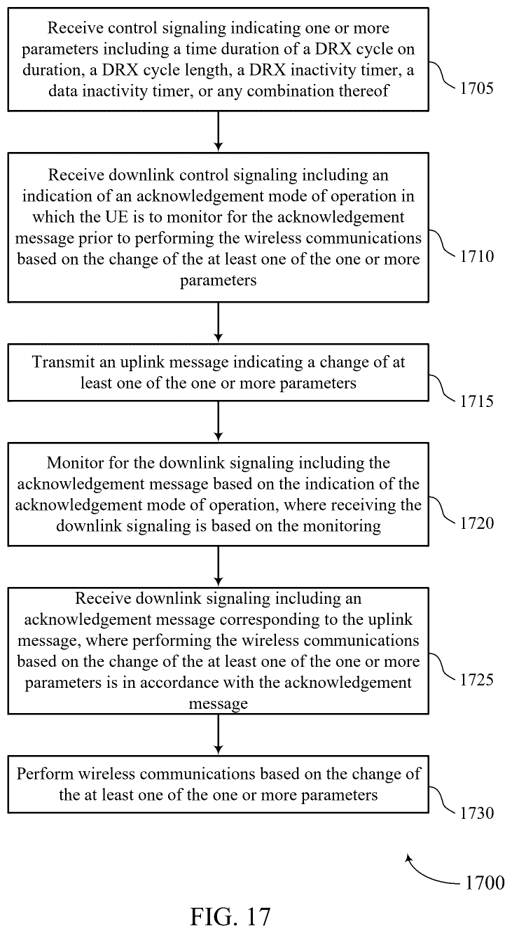

FIG. 17 shows a flowchart illustrating a method 1700 that provides a signaling framework for improved power configuration of various use cases in accordance with one or more aspects of the present disclosure. The operations of the method 1700 may be implemented by a UE or its components as described herein. For example, the operations of the method 1700 may be performed by a UE 115 as described with reference to FIGS. 1 through 15. In some examples, a UE may execute a set of instructions to control the functional elements of the UE to perform the described functions. Additionally, or alternatively, the UE may perform aspects of the described functions using special-purpose hardware.

At 1705, the method may include receiving control signaling indicating one or more parameters including a time duration of a DRX cycle on duration, a DRX cycle length, a DRX inactivity timer, a data inactivity timer, or any combination thereof. The operations of 1705 may be performed in accordance with examples as disclosed herein. In some examples, aspects of the operations of 1705 may be performed by a control signaling component 1425 as described with reference to FIG. 14.

At 1710, the method may include receiving downlink control signaling including an indication of an acknowledgement mode of operation in which the UE is to monitor for the acknowledgement message prior to performing the wireless communications based on the change of the at least one of the one or more parameters. The operations of 1710 may be performed in accordance with examples as disclosed herein. In some examples, aspects of the operations of 1710 may be performed by a control signaling component 1425 as described with reference to FIG. 14.

At 1715, the method may include transmitting an uplink message indicating a change of at least one of the one or more parameters. The operations of 1715 may be performed in accordance with examples as disclosed herein. In some examples, aspects of the operations of 1715 may be performed by an uplink message component 1430 as described with reference to FIG. 14.

At 1720, the method may include monitoring for the downlink signaling including the acknowledgement message based on the indication of the acknowledgement mode of operation, where receiving the downlink signaling is based on the monitoring. The operations of 1720 may be performed in accordance with examples as disclosed herein. In some examples, aspects of the operations of 1720 may be performed by a downlink signaling component 1445 as described with reference to FIG. 14.

At 1725, the method may include receiving downlink signaling including an acknowledgement message corresponding to the uplink message, where performing the wireless communications based on the change of the at least one of the one or more parameters is in accordance with the acknowledgement message. The operations of 1725 may be performed in accordance with examples as disclosed herein. In some examples, aspects of the operations of 1725 may be performed by a downlink signaling component 1445 as described with reference to FIG. 14.

At 1730, the method may include performing wireless communications based on the change of the at least one of the one or more parameters. The operations of 1730 may be performed in accordance with examples as disclosed herein. In some examples, aspects of the operations of 1730 may be performed by a wireless communications component 1435 as described with reference to FIG. 14.

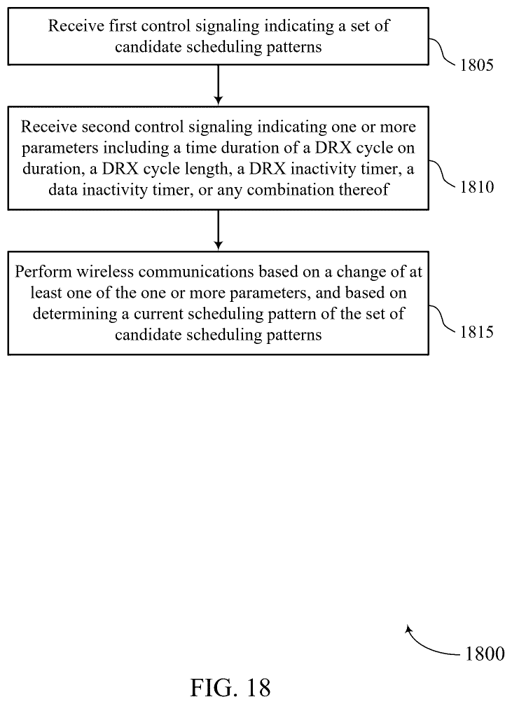

FIG. 18 shows a flowchart illustrating a method 1800 that provides a signaling framework for improved power configuration of various use cases in accordance with one or more aspects of the present disclosure. The operations of the method 1800 may be implemented by a UE or its components as described herein. For example, the operations of the method 1800 may be performed by a UE 115 as described with reference to FIGS. 1 through 15. In some examples, a UE may execute a set of instructions to control the functional elements of the UE to perform the described functions. Additionally, or alternatively, the UE may perform aspects of the described functions using special-purpose hardware.

At 1805, the method may include receiving first control signaling indicating a set of candidate scheduling patterns. The operations of 1805 may be performed in accordance with examples as disclosed herein. In some examples, aspects of the operations of 1805 may be performed by a scheduling pattern component 1440 as described with reference to FIG. 14.

At 1810, the method may include receiving second control signaling indicating one or more parameters including a time duration of a DRX cycle on duration, a DRX cycle length, a DRX inactivity timer, a data inactivity timer, or any combination thereof. The operations of 1810 may be performed in accordance with examples as disclosed herein. In some examples, aspects of the operations of 1810 may be performed by a control signaling component 1425 as described with reference to FIG. 14.

At 1815, the method may include performing wireless communications based on a change of at least one of the one or more parameters, and based on determining a current scheduling pattern of the set of candidate scheduling patterns. The operations of 1815 may be performed in accordance with examples as disclosed herein. In some examples, aspects of the operations of 1815 may be performed by a wireless communications component 1435 as described with reference to FIG. 14.

The following provides an overview of aspects of the present disclosure:

Aspect 1: A method for wireless communications at a UE, comprising: receiving control signaling indicating one or more parameters comprising a time duration of a DRX cycle on duration, a DRX cycle length, a DRX inactivity timer, a data inactivity timer, or any combination thereof; transmitting an uplink message indicating a change of at least one of the one or more parameters; and performing wireless communications based at least in part on the change of the at least one of the one or more parameters.

Aspect 2: The method of aspect 1, wherein transmitting the uplink message comprises: transmitting, prior to expiration of the DRX inactivity timer, an indication to terminate the DRX inactivity timer.

Aspect 3: The method of any of aspects 1 through 2, wherein transmitting the uplink message comprises: transmitting, during an on duration of a DRX cycle, a request to pause uplink grants, downlink grants, or both, for a remainder of the on duration.

Aspect 4: The method of any of aspects 1 through 3, further comprising: receiving downlink signaling comprising an acknowledgement message corresponding to the uplink message, wherein performing the wireless communications based at least in part on the change of the at least one of the one or more parameters is in accordance with the acknowledgement message.

Aspect 5: The method of aspect 4, wherein the downlink signaling comprises a DCI message, a MAC-CE, a random access message, or any combination thereof.

Aspect 6: The method of any of aspects 4 through 5, further comprising: receiving downlink control signaling comprising an indication of an acknowledgement mode of operation in which the UE is to monitor for the acknowledgement message prior to performing the wireless communications based on the change of the at least one of the one or more parameters; and monitoring for the downlink signaling comprising the acknowledgement message based at least in part on the indication of the acknowledgement mode of operation, wherein receiving the downlink signaling is based at least in part on the monitoring.

Aspect 7: The method of any of aspects 1 through 6, further comprising: receiving downlink control signaling comprising an indication of an unacknowledged mode of operation in which the UE is to perform wireless communications based on the change of the at least one of the one or more parameters without receiving an acknowledgement message; and entering a DRX sleep state based at least in part on the indication of the unacknowledged mode of operation.

Aspect 8: The method of any of aspects 1 through 7, wherein the uplink message comprises a MAC-CE, an UCI message, a random access message, a NAS SR, or any combination thereof.

Aspect 9: The method of aspect 8, wherein the uplink message comprises an indication of a set of candidate values corresponding to the one or more parameters.

Aspect 10: The method of aspect 9, further comprising: receiving downlink signaling approving or denying each candidate value of the set of candidate values, wherein the change of the at least one of the one or more parameters is based at least in part on receiving the downlink signaling.

Aspect 11: The method of aspect 10, wherein the downlink signaling comprises a DCI message, a MAC-CE, a random access message, or any combination thereof.

Aspect 12: The method of any of aspects 8 through 11, wherein transmitting the uplink message comprises: transmitting, prior to expiration of the data inactivity timer, an indication to terminate the data inactivity timer.

Aspect 13: The method of any of aspects 8 through 12, wherein the uplink message further comprises an indication of a RRC state, the change of the at least one of the one or more parameters is based at least in part on the indication.

Aspect 14: The method of aspect 13, further comprising: receiving, responsive to the indication of the RRC state, a RRC release message, wherein performing the wireless communications is based at least in part on the RRC release message.

Aspect 15: The method of any of aspects 8 through 14, wherein the uplink message comprises a report comprising an application type, a data rate transfer requirement, a data burst periodicity, an application latency requirement, or any combination thereof, the change of the at least one of the one or more parameters is based at least in part on transmitting the report.

Aspect 16: The method of aspect 15, further comprising: receiving downlink signaling based at least in part on the uplink message comprising the report, the downlink signaling comprising an indication of one or more updated parameter values, the one or more updated parameter values comprising an updated DRX cycle on duration, an updated DRX cycle length, an updated DRX inactivity timer, an updated data inactivity timer, a SSSG switching parameter, a PDCCH skipping parameter, a BWP, a quantity of reception layers, a quantity of transmission layers, a quantity of uplink secondary carriers to be activated, a quantity of downlink secondary carriers to be activated, a quantity of active uplink secondary carriers to be deactivated, a quantity of active downlink secondary carriers to be deactivated, or any combination thereof, wherein the change of the at least one of the one or more parameters is based at least in part on the one or more updated parameter values.

Aspect 17: A UE for wireless communications, comprising one or more memories storing processor-executable code, and one or more processors coupled with the one or more memories and individually or collectively operable to execute the code to cause the UE to: receive first control signaling indicating a set of candidate scheduling patterns; receive second control signaling indicating one or more parameters comprising a time duration of a DRX cycle on duration, a DRX cycle length, a DRX inactivity timer, a data inactivity timer, or any combination thereof; and perform wireless communications based on a change of at least one of the one or more parameters, and based at least in part on determining a current scheduling pattern of the set of candidate scheduling patterns.

Aspect 18: The UE of aspect 17, wherein the first control signaling comprises system information, a RRC signaling message, a MAC-CE, a DCI message, or any combination thereof.

Aspect 19: A UE for wireless communications, comprising one or more memories storing processor-executable code, and one or more processors coupled with the one or more memories and individually or collectively operable to execute the code to cause the UE to perform a method of any of aspects 1 through 16.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive control signaling indicating one or more parameters comprising a time duration of a discontinuous reception (DRX) cycle on duration, a DRX cycle length, a DRX inactivity timer, a data inactivity timer, or any combination thereof;
transmit an uplink message indicating a change of at least one of the one or more parameters; and
perform wireless communications based at least in part on the change of the at least one of the one or more parameters.

2. The UE of claim 1, wherein, to transmit the uplink message, the one or more processors are individually or collectively operable to execute the code to cause the UE to:
transmit, prior to expiration of the DRX inactivity timer, an indication to terminate the DRX inactivity timer.

3. The UE of claim 1, wherein, to transmit the uplink message, the one or more processors are individually or collectively operable to execute the code to cause the UE to:
transmit, during an on duration of a DRX cycle, a request to pause uplink grants, downlink grants, or both, for a remainder of the on duration.

4. The UE of claim 1, wherein the one or more processors are individually or collectively further operable to execute the code to cause the UE to:
receive downlink signaling comprising an acknowledgement message corresponding to the uplink message, wherein performing the wireless communications based at least in part on the change of the at least one of the one or more parameters is in accordance with the acknowledgement message.

5. The UE of claim 4, wherein the downlink signaling comprises a downlink control information message, a medium access control (MAC) control element (CE), a random access message, or any combination thereof.

6. The UE of claim 4, wherein the one or more processors are individually or collectively further operable to execute the code to cause the UE to:
receive downlink control signaling comprising an indication of an acknowledgement mode of operation in which the UE is to monitor for the acknowledgement message prior to performing the wireless communications based on the change of the at least one of the one or more parameters; and
monitor for the downlink signaling comprising the acknowledgement message based at least in part on the indication of the acknowledgement mode of operation, wherein receiving the downlink signaling is based at least in part on the monitoring.

7. The UE of claim 1, wherein the one or more processors are individually or collectively further operable to execute the code to cause the UE to:
receive downlink control signaling comprising an indication of an unacknowledged mode of operation in which the UE is to perform wireless communications based on the change of the at least one of the one or more parameters without receiving an acknowledgement message; and
enter a DRX sleep state based at least in part on the indication of the unacknowledged mode of operation.

8. The UE of claim 1, wherein the uplink message comprises a medium access control (MAC) control element (CE), an uplink control information message, a random access message, a non-access stratum scheduling request, or any combination thereof.

9. The UE of claim 8, wherein the uplink message comprises an indication of a set of candidate values corresponding to the one or more parameters.

10. The UE of claim 9, wherein the one or more processors are individually or collectively further operable to execute the code to cause the UE to:
receive downlink signaling approving or denying each candidate value of the set of candidate values, wherein the change of the at least one of the one or more parameters is based at least in part on receiving the downlink signaling.

11. The UE of claim 10, wherein the downlink signaling comprises a downlink control information message, a medium access control (MAC) control element (CE), a random access message, or any combination thereof.

12. The UE of claim 8, wherein, to transmit the uplink message, the one or more processors are individually or collectively operable to execute the code to cause the UE to:
transmit, prior to expiration of the data inactivity timer, an indication to terminate the data inactivity timer.

13. The UE of claim 8, wherein the uplink message further comprises an indication of a radio resource control state, wherein the change of the at least one of the one or more parameters is based at least in part on the indication.

14. The UE of claim 13, wherein the one or more processors are individually or collectively further operable to execute the code to cause the UE to:
receive, responsive to the indication of the radio resource control state, a radio resource control release message, wherein performing the wireless communications is based at least in part on the radio resource control release message.

15. The UE of claim 8, wherein the uplink message comprises a report comprising an application type, a data rate transfer requirement, a data burst periodicity, an application latency requirement, or any combination thereof, wherein the change of the at least one of the one or more parameters is based at least in part on transmitting the report.

16. The UE of claim 15, wherein the one or more processors are individually or collectively further operable to execute the code to cause the UE to:
receive downlink signaling based at least in part on the uplink message comprising the report, the downlink signaling comprising an indication of one or more updated parameter values, the one or more updated parameter values comprising an updated discontinuous reception (DRX) cycle on duration, an updated DRX cycle length, an updated DRX inactivity timer, an updated data inactivity timer, a search space set group switching parameter, a physical downlink control channel skipping parameter, a bandwidth part, a quantity of reception layers, a quantity of transmission layers, a quantity of uplink secondary carriers to be activated, a quantity of downlink secondary carriers to be activated, a quantity of active uplink secondary carriers to be deactivated, a quantity of active downlink secondary carriers to be deactivated, or any combination thereof, wherein the change of the at least one of the one or more parameters is based at least in part on the one or more updated parameter values.

17. A user equipment (UE), comprising:
one or more memories storing processor-executable code; and
one or more processors coupled with the one or more memories and individually or collectively operable to execute the code to cause the UE to:
receive first control signaling indicating a set of candidate scheduling patterns;
receive second control signaling indicating one or more parameters comprising a time duration of a discontinuous reception (DRX) cycle on duration, a DRX cycle length, a DRX inactivity timer, a data inactivity timer, or any combination thereof; and
perform wireless communications based on a change of at least one of the one or more parameters, and based at least in part on determining a current scheduling pattern of the set of candidate scheduling patterns.

18. The UE of claim 17, wherein the first control signaling comprises system information, a radio resource control signaling message, a medium access control (MAC) control element (CE), a downlink control information message, or any combination thereof.

19. A method for wireless communications at a user equipment (UE), comprising:
receiving control signaling indicating one or more parameters comprising a time duration of a discontinuous reception (DRX) cycle on duration, a DRX cycle length, a DRX inactivity timer, a data inactivity timer, or any combination thereof;
transmitting an uplink message indicating a change of at least one of the one or more parameters; and
performing wireless communications based at least in part on the change of the at least one of the one or more parameters.

20. The method of claim 19, wherein transmitting the uplink message comprises:
transmitting, prior to expiration of the DRX inactivity timer, an indication to terminate the DRX inactivity timer.
